(19) United States
(12) Patent Application Publication
(10) Pub. No.: US 2018/0327609 A1
(43) Pub. Date: Nov. 15, 2018

(54) METHOD FOR MANUFACTURING THERMALLY INSULATED BODY, AND THERMALLY INSULATED BODY

(71) Applicant: HITACHI CHEMICAL COMPANY, LTD., Tokyo (JP)

(72) Inventors: Tatsuya MAKINO, Chiyoda-ku, Tokyo (JP); Hiroyuki IZUMI, Chiyoda-ku, Tokyo (JP); Yuta AKASU, Chiyoda-ku, Tokyo (JP); Tomohiko KOTAKE, Chiyoda-ku, Tokyo (JP); Chisato KIKKAWA, Chiyoda-ku, Tokyo (JP); Masato MIYATAKE, Chiyoda-ku, Tokyo (JP)

(73) Assignee: HITACHI CHEMICAL COMPANY, LTD., Tokyo (JP)

(21) Appl. No.: 15/755,822

(22) PCT Filed: Aug. 25, 2016
(86) PCT No.: PCT/JP2016/074885

§ 371 Date: Feb. 27, 2018

(30) Foreign Application Priority Data
Aug. 28, 2015 (JP) 2015-169099
Aug. 28, 2015 (JP) 2015-169105
Aug. 28, 2015 (JP) 2015-169111
Aug. 28, 2015 (JP) 2015-169138

(51) Int. Cl. C09D 5/18; C09D 5/02; C09D 183/04; C09D 7/40; F16L 59/00

(52) U.S. Cl. CPC C09D 5/18; C09D 5/028; C09D 183/04; C08K 3/36; C09D 7/68; F16L 59/00; C09D 7/67

(57) ABSTRACT

The present invention relates to a method for manufacturing a thermally insulated body comprising a thermal insulating layer integrally formed with a thermal insulation object, the method comprising a step of applying sol to the thermal insulation object and forming a thermal insulating layer including aerogel from the sol, and a thermally insulated body comprising a thermal insulating layer integrally formed with a thermal insulation object, wherein the thermal insulating layer includes aerogel.

### TECHNICAL FIELD

The present invention relates to a method for manufacturing a thermally insulated body and a thermally insulated body.

### BACKGROUND ART

In recent years, as the demands on the comfort of living space and energy saving have increased, there is a tendency that the shapes of thermal insulation objects are complicated, and the installation space of thermal insulating materials is narrowed. Thus, further improvement in thermal insulation properties and reduction in thickness are required for thermal insulating materials used in these.

Conventional thermally insulated structures include, for example, expandable thermal insulating materials such as urethane foam and phenol foam as constituent materials. However, these materials have a narrow service temperature range and employ the thermal insulation properties of air. Therefore, materials that have a wide service temperature range and have better thermal insulation properties than those of air must be developed for further improvement in thermal insulation properties.

As thermal insulating materials having better thermal insulation properties than those of air, there are thermal insulating materials in which voids forming foam are filled with a low thermally conductive gas by use of chlorofluorocarbon or a chlorofluorocarbon alternative blowing agent, etc. However, such thermal insulating materials have the possibility of leak of the low thermally conductive gas due to time degradation, and reduction in thermal insulation properties is a concern (e.g., Patent Literature 1 described below).

Also, a vacuum insulating material having a core using inorganic fiber and a phenol resin binder is known (e.g., Patent Literature 2 described below). However, in the vacuum insulating material, thermal insulation properties decrease drastically due to a problem such as time degradation or scratches on packaging bags, and furthermore, there is the problem that the thermal insulating material has no flexibility and cannot be processed into curved surfaces because of being vacuum-packaged.

Since 1980s, studies on the thermal insulation of engine members have been started in order to improve the thermal efficiency of engines, and thermal insulating layers consisting of a ceramic sintered body or zirconia particles have been proposed as thermal insulating materials.

For example, the thermal insulation of engine members by using a ceramic sintered body is described in Patent Literature 3. For example, an internal-combustion engine with a thermal insulating layer formed by using a ceramic of zirconia (ZrO₂), silicon, titanium, or zirconium or the like, a ceramic composed mainly of carbon and oxygen, etc. is disclosed in Patent Literature 4.

Aerogel is known as a low thermally conductive material. For example, silica aerogel is described in Patent Literature 5.

### CITATION LIST

### Patent Literature

Patent Literature 1: Japanese Patent No. 4084516

Patent Literature 2: Japanese Patent No. 4898157

Patent Literature 3: Japanese Unexamined Patent Publication No. 2005-146925

Patent Literature 4: Japanese Unexamined Patent Publication No. 2009-243352

Patent Literature 5: U.S. Pat. No. 4,402,927

### SUMMARY OF INVENTION

### Technical Problem

Aerogel is considered to be a material having the lowest thermal conductivity at normal pressure. The aerogel has a microporous structure, whereby the transfer of a gas including air is suppressed so that thermal conduction decreases. For thermal insulation methods using aerogel, novel modes of use are required from the viewpoint of achieving an excellent thermal insulation effect on a wide variety of thermal insulation objects.

The present invention has been made in light of the situation described above, and an object thereof is to provide a method for manufacturing a thermally insulated body having excellent thermal insulation properties. Another object of the present invention is to provide a thermally insulated body having excellent thermal insulation properties.

### Solution to Problem

The present invention provides a method for manufacturing a thermally insulated body comprising a thermal insulating layer integrally formed with a thermal insulation object, the method comprising a step of applying sol to the thermal insulation object and forming a thermal insulating layer including aerogel from the sol.

According to the method for manufacturing a thermally insulated body according to the present invention, a thermally insulated body having excellent thermal insulation properties can be manufactured. Furthermore, according to the method for manufacturing a thermally insulated body according to the present invention, a thermally insulated body having excellent flame retardance and heat resistance can be manufactured while the falling of aerogel can be suppressed. Moreover, according to the method for manufacturing a thermally insulated body according to the present invention, a thermal insulating layer including aerogel can be integrally formed with a thermal insulation object. Thus, a thermally insulated body manufactured by the manufacturing method easily prevents a thermal insulating layer from being detached from a thermal insulation object and can have a stable thermal insulation effect.

As a thermal insulation method using aerogel, a method using an aerogel layer which is a separated body from a thermal insulation object is possible, and, for example, a mode of covering a thermal insulation object with a laminate having an aerogel layer disposed on a base material is possible. However, from the viewpoint of application to thermal insulation objects having a wide variety of shapes, it may be required that an excellent thermal insulation effect should be obtained without depending on the shapes of the thermal insulation objects. By contrast, according to the method for manufacturing a thermally insulated body according to the present invention, an excellent thermal insulation effect can be obtained on thermal insulation objects without depending on the shapes of the thermal insulation objects, because there is no need of using a laminate which is a separated body from a thermal insulation object.

In the manufacturing method, the thermal insulation object may have a main body part and a covering layer covering at least a portion of a surface of the main body part, and the sol may be applied onto at least the covering layer such that the covering layer becomes an intermediate layer. By this, the bonding strength and adhesion between the main body part and the thermal insulating layer improve, and the falling of the thermal insulating layer is further suppressed. Furthermore, by this, the storage stability of the main body part is also excellent because a thermal insulation effect can be stably obtained.

The present invention provides a thermally insulated body comprising a thermal insulating layer integrally formed with a thermal insulation object, wherein the thermal insulating layer includes aerogel.

The thermally insulated body according to the present invention has excellent thermal insulation properties. Furthermore, the thermally insulated body according to the present invention has excellent flame retardance and heat resistance and can also suppress the falling of aerogel. Moreover, since the thermal insulating layer is integrally joined with a main body part, the thermal insulating layer is easily prevented from being detached from the thermal insulation object, and therefore, a thermal insulation effect can be stably obtained.

In the thermally insulated body, the thermal insulation object may have a main body part and a covering layer covering at least a portion of a surface of the main body part, and the thermal insulating layer may be formed on at least the covering layer such that the covering layer becomes an intermediate layer. By this, the bonding strength and adhesion between the main body part and the thermal insulating layer improve, and the falling of the thermal insulating layer is further suppressed. Furthermore, by this, a thermally insulated body excellent in the storage stability of the main body part can be manufactured because a thermal insulation effect can be stably obtained.

A thickness of the covering layer may be 0.01 to 1000 μm. By this, the bonding strength between the thermal insulating layer and the main body part further improves.

The covering layer may contain a filler. By this, heat resistance further improves while the generation of cracks in the thermal insulating layer is suppressed. Furthermore, by this, the penetration of a material constituting the covering layer into the thermal insulating layer is suppressed, and high thermal insulation properties and adhesion can be achieved at higher levels.

The filler may be an inorganic filler. By this, the heat resistance of the covering layer improves.

The aerogel may be a dried product of wet gel being a condensate of sol containing at least one selected from the group consisting of a silicon compound having a hydrolyzable functional group or a condensable functional group, and a hydrolysis product of the silicon compound having a hydrolyzable functional group. By this, workability improves while thermal insulation properties, flame retardance and flexibility can be achieved at higher levels.

Aerogel tends to be very fragile. For example, monolithic aerogel may be broken by mere lifting by the hand. By contrast, aerogel sheets using aerogel and a reinforcing material have heretofore been devised. In this context, in the case where the aerogel itself is fragile, it is possible that problems associated with workability arise in such a way that the sheets rupture due to shock or folding work, and aerogel powders fall out of the sheets. On the other hand, provided that the aerogel is the one as mentioned above, it is considered that the problems associated with workability are less likely to arise.

The sol may further contain silica particles. By this, the thermal insulating layer is further strengthened while much better thermal insulation properties and flexibility can be achieved.

An average primary particle diameter of the silica particles may be 1 to 500 nm. By this, thermal insulation properties and flexibility improve more easily.

The thermal insulation object may be a component constituting an engine. The thermally insulated body according to the present invention has excellent thermal insulation properties and can therefore improve the thermal efficiency of engines. Also, the thermally insulated body according to the present invention is suitable for application to engines because of having excellent flame retardance and heat resistance while suppressing the peeling, falling, etc. of the thermal insulating layer.

The thermal insulation object may include at least one selected from the group consisting of metals, ceramics, glass and resins. By this, much better adhesion can be achieved.

### Advantageous Effects of Invention

According to the present invention, a method for manufacturing a thermally insulated body having excellent thermal insulation properties can be provided. According to the present invention, a method for manufacturing a thermally insulated body having excellent thermal insulation properties, flame retardance and heat resistance can be provided. According to the present invention, a thermally insulated body having excellent thermal insulation properties can be provided. According to the present invention, a thermally insulated body having excellent thermal insulation properties, flame retardance and heat resistance can be provided. According to the present invention, use of a thermal insulating layer including aerogel in a component constituting an engine can be provided.

### BRIEF DESCRIPTION OF DRAWINGS

FIG. 1 is a sectional view schematically showing a thermally insulated body according to one embodiment of the present invention.

FIG. 2 is a sectional view schematically showing a thermally insulated body according to one embodiment of the present invention.

FIG. 3 is a diagram showing a method for calculating the two-axis average primary particle diameter of particles.

FIG. 4 is a diagram illustrating a method for manufacturing a thermally insulated body according to one embodiment of the present invention.

FIG. 5 is a diagram illustrating a method for manufacturing a thermally insulated body according to one embodiment of the present invention.

### DESCRIPTION OF EMBODIMENTS

Hereinafter, embodiments of the present invention will be described in detail with reference to the drawings, if necessary. However, the present invention is not limited by the following embodiments.

### Definition

In the present specification, a numerical range represented by using “to” means a range including the numerical values described before and after “to” as the minimum value and the maximum value, respectively. In numerical ranges described in stages in the present specification, the upper limit value or the lower limit value of a numerical range of a certain stage may be replaced with the upper limit value or the lower limit value of a numerical range of a different stage. In a numerical range described in the present specification, the upper limit value or the lower limit value of the numerical range may be replaced with a value shown in Examples. “A or B” needs only to include either A or B and may include both. Materials listed in the present specification can be used each alone or in combination of two or more thereof, unless otherwise specified. In the present specification, in the case where a plurality of substances corresponding to each component are present in a composition, the content of each component in the composition means the total amount of the plurality of substances present in the composition, unless otherwise specified.

First, the thermally insulated body according to the present embodiment will be described. The thermally insulated body according to the present embodiment can be obtained by, for example, the method for manufacturing a thermally insulated body according to the present embodiment.

<Thermally Insulated Body>

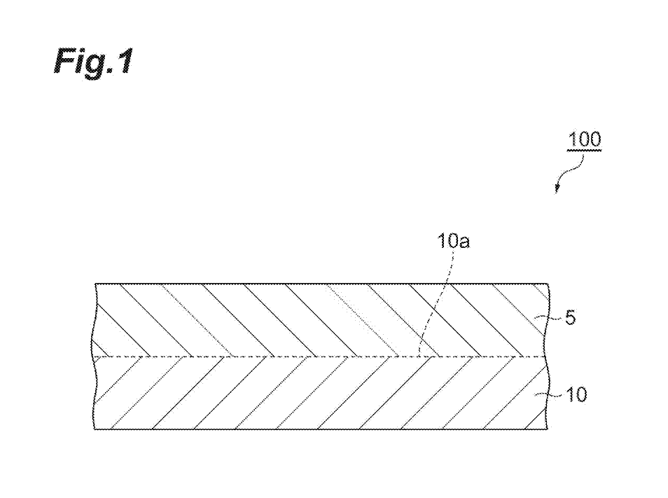

FIG. 1 is a sectional view schematically showing the thermally insulated body according to the present embodiment. A thermally insulated body (aerogel composite or aerogel composite structure) 100 according to the present embodiment has, as shown in FIG. 1, a structure comprising a thermal insulating layer 5 integrally formed with a thermal insulation object 10, and the thermal insulating layer 5 includes aerogel. Specifically, the thermally insulated body 100 may have a thermal insulation object 10 and a thermal insulating layer 5 integrally joined with the thermal insulation object 10. The thermal insulation object 10 is, for example, a support part supporting the thermal insulating layer 5. The thermally insulated body 100 according to the present embodiment is excellent in thermal insulation properties, flame retardance and heat resistance. The thermally insulated body 100 according to the present embodiment is also excellent in workability in forming the thermal insulating layer, and the peeling, falling, etc. of the thermal insulating layer is also suppressed.

The thermally insulated body 100 according to the present embodiment is, for example, a structure having the thermal insulating layer 5 disposed on at least a portion (a portion or the whole) of a surface 10a of the thermal insulation object 10. In the thermally insulated body 100 according to the present embodiment, excellent thermal insulation properties, flame retardance and heat resistance can be exerted because the thermal insulation object 10 and the thermal insulating layer 5 are integrally fixed. The surface 10a on which the thermal insulating layer 5 is disposed may be a flat surface, may be a composite planar surface (combination of slopes), or may be a curved surface.

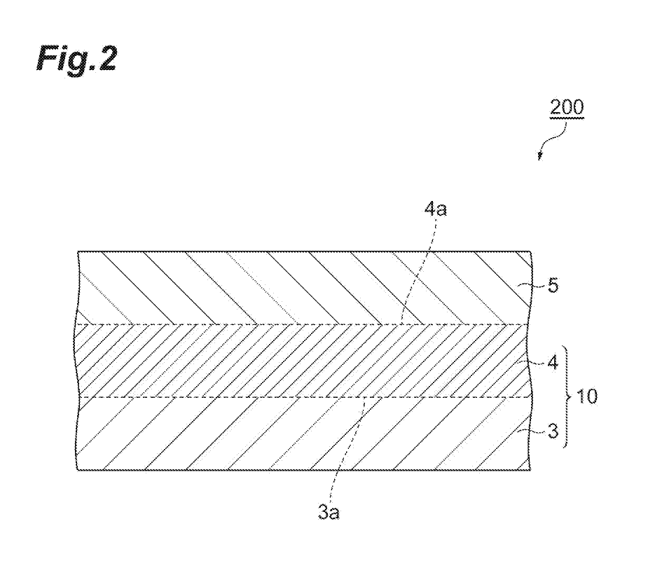

The thermal insulation object 10 may have, as shown in FIG. 2, a main body part 3 and a covering layer 4 covering at least a portion of a surface of the main body part 3. In this case, the thermal insulating layer 5 is formed on at least the covering layer 4 such that the covering layer 4 becomes an intermediate layer.

FIG. 2 is a sectional view schematically showing the thermally insulated body according to the present embodiment. A thermally insulated body (aerogel composite or aerogel composite structure) 200 according to the present embodiment has a structure where the thermal insulation object 10 has a main body part 3 and a covering layer 4 covering at least a portion of a surface of the main body part 3, and the thermal insulating layer 5 is formed on at least the covering layer 4 such that the covering layer 4 becomes an intermediate layer. Specifically, the thermally insulated body 200 may have a main body part 3 and a thermal insulating layer 5 integrally joined with the main body part 3 via a covering layer 4 serving as an intermediate layer. Also, in the thermally insulated body 200, the main body part 3, the covering layer 4, and the thermal insulating layer 5 are integrated. The main body part 3 is, for example, a support part supporting the thermal insulating layer 5. The thermally insulated body 200 according to the present embodiment is excellent in thermal insulation properties, flame retardance and heat resistance. Also, the thermally insulated body 200 according to the present embodiment is excellent in the bonding strength and adhesion between the main body part 3 and the thermal insulating layer 5 and can also suppress the falling of the thermal insulating layer 5 at a high level. The thermally insulated body 200 has a stable thermal insulation effect and is therefore also excellent in the storage stability of the main body part 3.

The thermally insulated body 200 according to the present embodiment is, for example, a structure having a covering layer (also referred to as an “intermediate layer”) 4 disposed on at least a portion of (a portion or the whole) of a surface 3a of the main body part 3, and a thermal insulating layer 5 disposed on at least a portion (a portion or the whole) of a surface 4a of the covering layer 4 on the side opposite to the main body part 3. In the thermally insulated body 200 according to the present embodiment, much better thermal insulation properties, flame retardance and heat resistance can be exerted because the main body part 3 and the thermal insulating layer 5 are integrally fixed via the covering layer 4 serving as an intermediate layer. Also, the thermally insulated body 200 according to the present embodiment is less susceptible to the types of a sol coating liquid and the main body part 3 and a manufacturing process and can be easily manufactured, because it has the covering layer 4 serving as an intermediate layer and can thereby reduce the chemical influence of a sol coating liquid mentioned later which is a precursor of the thermal insulating layer 5 on the main body part 3. The surface 3a on which the covering layer 4 is disposed may be a flat surface, may be a composite planar surface (combination of slopes), or may be a curved surface.

Although the aspect in which a thermal insulation object has a covering layer is described in FIG. 2, the covering layer is not always essential, and the thermal insulation object may be a main body part.

In the case where the thermal insulation object is a main body part, the thermally insulated body is, for example, a structure having a thermal insulating layer disposed on at least a portion (a portion or the whole) of a surface of the main body part, and has a structure where the main body part and the thermal insulating layer are in direct contact. In such a thermally insulated body, it is considered that reduction, etc. in thermal insulation properties, flame retardance and heat resistance caused by an intermediate layer can be suppressed because the main body part and the thermal insulating layer are integrated and fixed, and an adhesive layer (intermediate layer) is not included between the main body part and the thermal insulating layer 5. In this aspect as well, the surface of the main body part on which the thermal insulating layer is disposed may be a flat surface, may be a composite planar surface (combination of slopes), or may be a curved surface.

The aerogel according to the present embodiment may be a dried product of wet gel being a condensate of sol (wet gel derived from the sol) containing at least one selected from the group consisting of a silicon compound having a hydrolyzable functional group or a condensable functional group, and a hydrolysis product of the silicon compound having a hydrolyzable functional group (silicon compound in which the hydrolyzable functional group has been hydrolyzed). The aerogel is such matter, whereby thermal insulation properties, flame retardance and flexibility can be achieved at higher levels.

(Thermal Insulation Object)

As mentioned above, the thermal insulation object may be one having a main body part and a covering layer covering at least a portion of a surface of the main body part, or may be a main body part.

(Main Body Part)

Examples of the material constituting the main body part include metals, ceramics, glass, resins and composite materials thereof. The main body part may be in a form including at least one selected from the group consisting of, for example, metals, ceramics, glass and resins. A block form, a sheet form, a powder form, a spherical form, a fibrous form, or the like can be adopted as the form of the main body part according to the purpose or material used.

Examples of the metals include, but are not particularly limited to: simple substances of metals; alloys of metals; and metals with oxide layers formed. Examples of the metals include iron, copper, nickel, aluminum, zinc, titanium, chromium, cobalt, tin, gold, and silver. Depending on a material used in a sol production step mentioned later, simple substances of titanium, gold, silver, or the like, and iron and aluminum with an oxide layer formed can be used as the metals from the viewpoint of being excellent in the corrosion resistance of metal surface.

Examples of the ceramics include: oxides such as alumina, titania, zirconia, and magnesia; nitrides such as silicon nitride and aluminum nitride; carbides such as silicon carbide and boron carbide; and mixtures thereof.

Examples of the glass include quartz glass, soda glass, and borosilicate glass.

Examples of the resins include polyvinyl chloride, polyvinyl alcohol, polystyrene, polyethylene, polypropylene, polyacetal, polymethyl methacrylate, polycarbonate, polyimide, polyamide, and polyurethane.

Adhesion can be further improved by using a main body part having large surface roughness, or a main body part having a porous structure. The surface roughness (Ra) of the main body part may be, for example, 0.01 μm or larger, may be 0.02 μm or larger, may be 0.03 μm or larger, may be 0.1 μm (100 nm) or larger, and may be 0.5 μm (500 nm) or larger, from the viewpoint that a good anchoring effect is obtained, and the adhesion of the thermal insulating layer further improves, and from the viewpoint of suppressing the falling of the aerogel. The surface roughness (Ra) of the main body part may be, for example, 10 μm or smaller, may be 5 μm or smaller, and may be 3.5 μm or smaller, from the viewpoint that heat is less likely to conduct from the main body part, and thermal insulation performance improves. From these viewpoints, the surface roughness (Ra) of the main body part may be 0.01 to 10 μm, may be 0.02 to 5 μm, may be 0.03 to 3.5 μm, may be 0.1 to 3.5 μm, and may be 0.5 to 3.5 μm.

In this context, the surface roughness (Ra) refers to arithmetic average roughness defined by JIS B0601. More specifically, an average value in the case of setting a measurement range in one measurement to 20 mm×20 mm and measuring the surface five times (5 points) is regarded as the surface roughness (Ra) in the present specification.

An aspect in which the pores formed in the main body part having a porous structure are continuous holes, and the sum of pore volumes is 50 to 99% by volume of the total volume of the main body part is also acceptable from the viewpoint that thermal insulation properties improve more easily.

The thermal insulation object may be, for example, a component constituting an engine. The thermally insulated body according to the present embodiment has excellent thermal insulation properties and can therefore improve the thermal efficiency of engines. Also, the thermally insulated body according to the present embodiment is suitable for application to engines because of having excellent flame retardance and heat resistance while suppressing the peeling, falling, etc. of the thermal insulating layer. The main body part may be a component constituting an engine.

The component constituting an engine is not particularly limited as long as being a component applicable to engines, and is appropriately selectable by those skilled in the art. Examples of the engine include internal-combustion engines. There is no particular limitation on the material constituting the component constituting an engine, and, for example, the material mentioned above as the main body part may be used. Specific examples of the material constituting the component constituting an engine include metals, ceramics and composite materials thereof. The component may be in a form including at least one selected from the group consisting of, for example, metals and ceramics. The shape of the component is appropriately determined according to the form of an engine serving as a product.

In conventional thermal insulating layers, a thermal insulation effect is not sufficient. On the other hand, the thermal insulating layer according to the present embodiment has excellent thermal insulation properties applicable to engines. The thermal insulating layer according to the present embodiment has excellent thermal insulation properties and can therefore improve the thermal efficiency of engines. Also, the thermal insulating layer according to the present embodiment has excellent flame retardance and heat resistance applicable to engines.

If a ceramic sintered body as given in Patent Literature 3 described above is used in an engine, cracks ascribable to thermal stress and thermal shock, and the peeling of the ceramic sintered body caused by the cracks may occur. In the internal-combustion engine of Patent Literature 4 described above, heat energy applied to a thermal insulation film formation process is large, and working hours are more likely to become long, because a thermal insulating film is formed by sintering.

By contrast, although a method for forming a thermal insulating layer which involves mixing a resin and hollow particles to prepare a coating material, and applying this coating material to the wall surfaces of a combustion chamber to form a coating film, followed by baking is also possible, the hollow particles are broken in the mixing step, or the hollow particles aggregate and fall after film formation, whereby a thermal insulation effect is not sufficient in this method.

According to the present embodiment, workability is excellent while the peeling, falling, etc. of the thermal insulating layer is suppressed, because the thermal insulating layer including aerogel is formed.

In the present embodiment, use of a thermal insulating layer including aerogel in a component constituting an engine can be provided.

The thermal insulation object may include at least one selected from the group consisting of metals, ceramics, glass and resins from the viewpoint of achieving much better adhesion.

(Covering Layer (Intermediate Layer))

As mentioned above, the thermal insulation object may have a covering layer. Examples of the material constituting the covering layer include organic materials, inorganic materials and organic-inorganic hybrid materials.

Examples of the organic materials include polyimide, polyamide-imide, polybenzimidazole, polyether ether ketone, silicone and composite materials thereof. The organic material may be in a form including at least one selected from the group consisting of for example, polyimide, polyamide-imide, polybenzimidazole, poly ether ether ketone and silicone.

Examples of the inorganic materials include alumina, zirconia, silicon carbide, silicon nitride and sodium silicate. The inorganic material may be in a form including at least one selected from the group consisting of for example, alumina, zirconia, silicon carbide, silicon nitride and sodium silicate.

The inorganic material may further contain a binder. Examples of the binder include metal alkoxides and liquid glass.

Examples of the organic-inorganic hybrid materials include composite materials of the organic materials and the inorganic materials, epoxy-silica hybrid materials and acryl-silica hybrid materials.

The material constituting the covering layer may be an inorganic material or an organic-inorganic hybrid material from the viewpoint that heat resistance further improves, and may be an organic-inorganic hybrid material from the viewpoint of reducing the difference in thermal expansion between the main body part and the covering layer in the case of use in a high-temperature environment, and suppressing cracks. A material having a low modulus of elasticity can also be used as the material constituting the covering layer, from the viewpoint of suppressing cracks.

The covering layer may contain a filler from the viewpoint that heat resistance further improves, from the viewpoint of further suppressing cracks, and from the viewpoint that the penetration of the material constituting the covering layer into the thermal insulating layer is suppressed, and thermal insulation properties and adhesion further improve. Examples of the filler include inorganic fillers and organic fillers. The filler may be an inorganic filler because of improving the upper temperature limit (heat resistance) of the covering layer and being easily used in a high-temperature environment, and may be an organic filler from the viewpoint that heat cycle reliability in the case of repetitive use in a high-temperature environment improves. As the reason why the heat resistance of the covering layer improves when the filler is an inorganic filler, it is considered that, for example, heat that has entered the thermal insulating layer is efficiently transferred to the component so that the accumulation of heat at the boundary zone between the covering layer and the thermal insulating layer can be suppressed. There is no particular limitation on the shape of the filler, and, for example, a short fiber form, a fine powder form and a hollow form are acceptable.

Examples of the material constituting the inorganic filler include silica, mica, talc, glass, calcium carbonate, quartz, metal hydrates, metal hydroxides and composite materials thereof. The inorganic filler may be in a form including at least one selected from the group consisting of for example, silica, mica, talc, glass, calcium carbonate, quartz, metal hydrates and metal hydroxides.

Examples of the metal hydrates include potassium aluminum sulfate dodecahydrate, magnesium nitrate hexahydrate, and magnesium sulfate heptahydrate. Examples of the metal hydroxides include aluminum hydroxide and magnesium hydroxide. The aluminum hydroxide may be boehmite-type aluminum hydroxide.

The inorganic filler may be one containing silica, glass or a metal hydroxide, the glass may be glass short fiber or hollow glass, and the metal hydroxide may be magnesium hydroxide or boehmite-type aluminum hydroxide, from the viewpoint that heat resistance and flame retardance further improve.

Examples of the material constituting the organic filler include phosphoric acid ester, polyester, polystyrene, pulp, elastomers and composite materials thereof. The organic filler may be in a form including at least one selected from the group consisting of for example, phosphoric acid ester, polyester, polystyrene, pulp and elastomers. The pulp may be in the form of pulp flock. The organic filler may be one containing an elastomer because the difference in thermal expansion between the main body part and the covering layer is stress-relaxed, and cracks are easily suppressed.

Examples of the elastomer include styrene-based elastomers, olefin-based elastomers, urethane-based elastomers, polybutadiene-based elastomers, fluorine-based elastomers and silicone-based elastomers. Among these, a fluorine-based elastomer or a silicone-based elastomer can be used as the elastomer from the viewpoint that heat resistance further improves.

The content of the filler contained in the covering layer may be 0.1% by volume or more with respect to the total volume of the covering layer from the viewpoint that heat resistance further improves. The content of the filler contained in the covering layer may be 50% by volume or less, may be 40% by volume or less, and may be 30% by volume or less, with respect to the total volume of the covering layer from the viewpoint that workability in forming the covering layer improves, and from the viewpoint that the adhesion between the main body part and the thermal insulating layer improves. From these viewpoints, the content of the filler contained in the covering layer may be 0.1 to 50% by volume, may be 0.1 to 40% by volume, and may be 0.1 to 30% by volume, with respect to the total volume of the covering layer.

The covering layer may contain, for example, an adhesion improver, a flame retardant and an antioxidant.

Examples of the adhesion improver include: urea compounds such as urea silane; and silane coupling agents.

Examples of the flame retardant include melamine cyanurate and bis(pentabromophenyl)ethane.

Examples of the antioxidant include antioxidants consisting of a ceramic powder such as alumina or zirconia and an inorganic binder.

The thermal decomposition temperature of the covering layer may be 300° C. or higher from the viewpoint that heat resistance further improves. It is considered that such a covering layer resists thermal degradation even against the operation of engines, and has a long life-span. In this context, the thermal decomposition temperature of 300° C. or higher means that the temperature at which the weight decreases by 5% is 300° C. or higher in the case of measuring the material under conditions involving a rate of temperature increase of 10° C./min in a nitrogen atmosphere by using a high-temperature-type simultaneous thermogravimetric analyzer-differential thermal analyzer TG/DTA 7300 manufactured by SII Nanotechnology Inc.

The thickness of the covering layer may be 0.01 μm or larger, may be 0.1 μm or larger, and may be 1 μm or larger, from the viewpoint that damage ascribable to shock, etc. is reduced, and the protection performance of the main body part improves, and from the viewpoint that the bonding strength between the main body part and the thermal insulating layer further improves. The thickness of the covering layer may be 1000 μm or smaller, may be smaller than 1000 μm, and may be 500 μm or smaller, from the viewpoint of suppressing cracks at the time of the formation of the covering layer. The thickness of the covering layer may be 100 μm or smaller from the viewpoint of suppressing cracks ascribable to the difference in thermal expansion between the main body part and the thermal insulating layer, and from the viewpoint that heat cycle stability improves. From these viewpoints, the thickness of the covering layer may be 0.01 to 1000 μm, may be 0.01 to 500 μm, and may be 0.01 to 100 μm.

The chemical influence of water-soluble acidic substances or basic substances and inorganic salts, etc. on the main body part can be further reduced by using a covering layer having a low percentage of water absorption. Specifically, for example, chemical change (corrosion, denaturation, etc.) in the main body part caused by the influence of a sol coating liquid mentioned later, etc. can be further reduced. In short, it is less susceptible to conditions for forming the thermal insulating layer and the composition of the sol coating liquid, and the manufacture of the thermally insulated body becomes easy. From these viewpoints, the percentage of water absorption of the covering layer may be less than 5%, may be less than 4%, and may be less than 3%.

The percentage of water absorption of the covering layer means the rate of change in mass in leaving a test specimen molded from a constituent material of the covering layer into a size of 20 mm×20 mm×0.5 mm, for 6 hours in a thermo-hygrostat of 60° C. and 90% RH.

The adhesion between the covering layer and the thermal insulating layer can be further improved, and the peeling and falling of the thermal insulating layer can be further suppressed, by using a covering layer having large surface roughness. The surface roughness (Ra) of the covering layer may be, for example, 200 nm or larger, may be 300 nm or larger, and may be 500 nm or larger, from the viewpoint that a good anchoring effect is obtained between the covering layer and the thermal insulating layer, and the adhesion of the thermal insulating layer further improves.

The surface roughness of the covering layer can be adjusted, for example, by forming the covering layer on the main body part, and then subjecting the covering layer to a polishing process (polishing treatment) or a roughening process (roughening treatment). The polishing process or the roughening process may be machine processing or may be chemical processing. Examples of the processing method include: machine processing with slurry or abrasive grains such as an abrasive; wet etching with an acid or a base, an oxidizing agent or a reducing agent; and dry etching with sulfur hexafluoride or carbon tetrafluoride.

The covering layer may be a single layer or may be a plurality of layers. In the case where the covering layer is a plurality of layers, the placement of each layer can be determined according to the purpose. The covering layer is a plurality of layers, whereby, for example, bonding strength can be further improved, the main body part can be further favorably protected, and heat resistance can be further improved.

A covering layer other than those described above (hereinafter, referred to as an “additional covering layer”) can also be used as the covering layer.

(Additional Covering Layer)

Examples of the material constituting the additional covering layer include resins, glass, ceramics, metals and composite materials thereof.

Examples of the resins include polyurethane, polyester, polyimide, acrylic resin, phenol resin, and epoxy resin.

Examples of the ceramics include metal oxides such as alumina, zirconia, magnesia, and titania.

Examples of the metals include titanium, chromium, aluminum, copper and platinum.

The additional covering layer may be, for example, a layer constituted by a ceramic (ceramic layer) or a layer constituted by a metal (metal layer) from the viewpoint that heat resistance further improves.

{Thermal Insulating Layer}

The thermal insulating layer according to the present embodiment includes aerogel. The thermal insulating layer may be an aerogel layer constituted by aerogel. The thermal insulating layer may include an inorganic fibrous substance from the viewpoint of strengthening the thermal insulating layer, and suppressing the breakage of the thermal insulating layer ascribable to shock (e.g., shock generated by engine operation). Examples of the inorganic fibrous substance include glass fiber, carbon fiber, activated carbon fiber, ceramic fiber and rock wool. These inorganic fibrous substances may be used each alone or in combination of two or more thereof. In the case where the thermal insulating layer contains an inorganic fibrous substance, the content of the inorganic fibrous substance may be 5% by mass or less, may be 4% by mass or less, and may be 3% by mass or less, on the basis of the total mass of the aerogel included in the thermal insulating layer from the viewpoint of easily obtaining good thermal insulation properties. Hereinafter, the aerogel contained in the thermal insulating layer according to the present embodiment will be described.

(Aerogel)

Although dry gel obtained by using a supercritical drying method for wet gel is called aerogel; dry gel obtained by drying under atmospheric pressure is called xerogel; and dry gel obtained by freeze drying is called cryogel in the narrow sense, low-density dry gel obtained regardless of these drying approaches of wet gel is referred to as “aerogel” in the present embodiment. Specifically, in the present embodiment, the “aerogel” means “gel comprised of a microporous solid in which the dispersed phase is a gas” which is aerogel in the broad sense. In general, the inside of the aerogel has a network microstructure and has a cluster structure where aerogel particles (particles constituting the aerogel) on the order of 2 to 20 nm are bonded. Pores smaller than 100 nm reside between skeletons formed by this cluster. By this, the aerogel has a three-dimensionally fine and porous structure. The aerogel according to the present embodiment is, for example, silica aerogel composed mainly of silica. Examples of the silica aerogel include so-called organic-inorganic hybridized silica aerogel in which an organic group (a methyl group, etc.) or an organic chain is introduced. The thermal insulating layer may be a layer containing aerogel having a polysiloxane-derived structure.

The aerogel according to the present embodiment may be a dried product of wet gel being a condensate of sol containing at least one selected from the group consisting of a silicon compound having a hydrolyzable functional group or a condensable functional group (in the molecule), and a hydrolysis product of the silicon compound having a hydrolyzable functional group. Specifically, the aerogel according to the present embodiment may be one obtained by drying wet gel produced from sol containing at least one selected from the group consisting of a silicon compound having a hydrolyzable functional group or a condensable functional group (in the molecule), and a hydrolysis product of the silicon compound having a hydrolyzable functional group. By adopting these aspects, thermal insulation properties and flexibility further improve. The condensate may be obtained by the condensation reaction of a hydrolysis product obtained by the hydrolysis of the silicon compound having a hydrolyzable functional group, or may be obtained by the condensation reaction of the silicon compound having a condensable functional group which is not a functional group obtained by hydrolysis. The silicon compound can have at least one of the hydrolyzable functional group and the condensable functional group and may have both of the hydrolyzable functional group and the condensable functional group. Each aerogel mentioned later may be such a dried product of wet gel being a condensate of sol (one obtained by drying wet gel produced from the sol) containing at least one selected from the group consisting of a silicon compound having a hydrolyzable functional group or a condensable functional group, and a hydrolysis product of the silicon compound having a hydrolyzable functional group.

The aerogel layer may be a layer constituted by a dried product of wet gel being a condensate of sol containing at least one selected from the group consisting of a silicon compound having a hydrolyzable functional group or a condensable functional group, and a hydrolysis product of the silicon compound having a hydrolyzable functional group. Specifically, the aerogel layer may be constituted by a layer prepared by drying wet gel produced from sol containing at least one selected from the group consisting of a silicon compound having a hydrolyzable functional group or a condensable functional group, and a hydrolysis product of the silicon compound having a hydrolyzable functional group. Specifically, the thermal insulating layer may be an aerogel layer constituted by a dried product of wet gel being a condensate of sol containing at least one selected from the group consisting of a silicon compound having a hydrolyzable functional group or a condensable functional group, and a hydrolysis product of the silicon compound having a hydrolyzable functional group, or may be constituted by an aerogel layer prepared by drying wet gel produced from sol containing at least one selected from the group consisting of a silicon compound having a hydrolyzable functional group or a condensable functional group, and a hydrolysis product of the silicon compound having a hydrolyzable functional group.

The aerogel according to the present embodiment can contain polysiloxane having a principal chain including a siloxane bond (Si—O—Si). The aerogel can have the following M unit, D unit, T unit or Q unit as a structural unit.

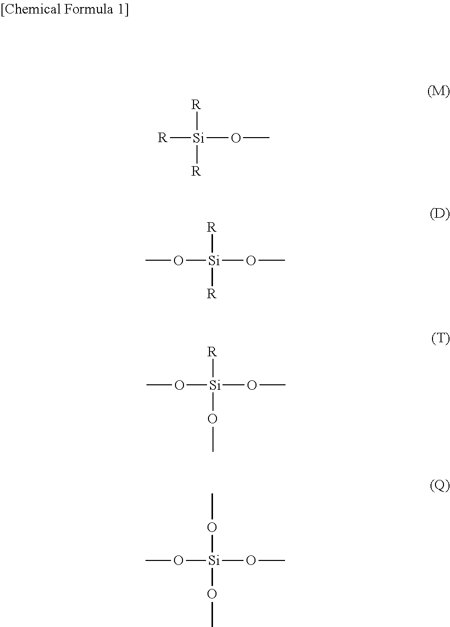

In the above formulas, R represents an atom (a hydrogen atom, etc.) or an atomic group (an alkyl group, etc.) bonded to the silicon atom. The M unit is a unit consisting of a monovalent group in which the silicon atom is bonded to one oxygen atom. The D unit is a unit consisting of a divalent group in which the silicon atom is bonded to two oxygen atoms. The T unit is a unit consisting of a trivalent group in which the silicon atom is bonded to three oxygen atoms. The Q unit is a unit consisting of a tetravalent group in which the silicon atom is bonded to four oxygen atoms. Information on the contents of these units can be obtained by Si-NMR.

The aerogel according to the present embodiment may contain silsesquioxane. The silsesquioxane is polysiloxane having the T unit as a structural unit, and has the composition formula: (RSiO_{1.5})ₙ. The silsesquioxane can have various skeletal structures such as cage type, ladder type, and random type.

Examples of the hydrolyzable functional group include alkoxy groups. Examples of the condensable functional group (except for functional groups corresponding to the hydrolyzable functional group) include a hydroxy group, silanol groups, a carboxyl group and a phenolic hydroxy group. The hydroxy group may be included in a hydroxy group-containing group such as a hydroxyalkyl group. Each of the hydrolyzable functional group and the condensable functional group may be used alone or by mixing two or more types.

The silicon compound may include a silicon compound having an alkoxy group as the hydrolyzable functional group, and can include a silicon compound having a hydroxyalkyl group as the condensable functional group. The silicon compound can have at least one selected from the group consisting of alkoxy groups, silanol groups, hydroxyalkyl groups and polyether groups from the viewpoint that the flexibility of the aerogel further improves. The silicon compound can have at least one selected from the group consisting of alkoxy groups and hydroxyalkyl groups from the viewpoint that the compatibility of sol improves.

The number of carbon atoms of each of the alkoxy groups and the hydroxyalkyl groups can be set to 1 to 6 from the viewpoint of improvement in the reactivity of the silicon compound and reduction in the thermal conductivity of the aerogel, and may be 2 to 4 from the viewpoint that the flexibility of the aerogel further improves. Examples of the alkoxy groups include a methoxy group, an ethoxy group, and a propoxy group. Examples of the hydroxyalkyl groups include a hydroxymethyl group, a hydroxyethyl group, and a hydroxypropyl group.

Examples of the aerogel according to the present embodiment include aspects given below. By adopting these aspects, it becomes easy to obtain aerogel excellent in thermal insulation properties, flame retardance, heat resistance and flexibility. Particularly, flexibility is excellent, whereby the thermal insulating layer can be more easily formed into even a shape heretofore difficult to form. By adopting each of the aspects, aerogel having thermal insulation properties, flame retardance and flexibility appropriate for each of the aspects can be obtained.

(First Aspect)

The aerogel according to the present embodiment may be a dried product of wet gel being a condensate of sol containing at least one compound selected from the group consisting of a polysiloxane compound having a hydrolyzable functional group or a condensable functional group (in the molecule), and a hydrolysis product of the polysiloxane compound having a hydrolyzable functional group (polysiloxane compound in which the hydrolyzable functional group has been hydrolyzed) (hereinafter, referred to as the “polysiloxane compound group” in some cases). Specifically, the aerogel according to the present embodiment may be one obtained by drying wet gel produced from sol containing at least one selected from the group consisting of a polysiloxane compound having a hydrolyzable functional group or a condensable functional group (in the molecule), and a hydrolysis product of the polysiloxane compound having a hydrolyzable functional group. Each aerogel mentioned later may also be such a dried product of wet gel being a condensate of sol (one obtained by drying wet gel produced from the sol) containing at least one selected from the group consisting of a polysiloxane compound having a hydrolyzable functional group or a condensable functional group, and a hydrolysis product of the polysiloxane compound having a hydrolyzable functional group.

The aerogel layer may be a layer constituted by a dried product of wet gel being a condensate of sol containing at least one selected from the group consisting of a polysiloxane compound having a hydrolyzable functional group or a condensable functional group, and a hydrolysis product of the polysiloxane compound having a hydrolyzable functional group. Specifically, the aerogel layer may be constituted by a layer prepared by drying wet gel produced from sol containing at least one selected from the group consisting of a polysiloxane compound having a hydrolyzable functional group or a condensable functional group, and a hydrolysis product of the polysiloxane compound having a hydrolyzable functional group. Specifically, the thermal insulating layer may be an aerogel layer constituted by a dried product of wet gel being a condensate of sol containing at least one selected from the group consisting of a polysiloxane compound having a hydrolyzable functional group or a condensable functional group, and a hydrolysis product of the polysiloxane compound having a hydrolyzable functional group, or may be constituted by an aerogel layer prepared by drying wet gel produced from sol containing at least one selected from the group consisting of a polysiloxane compound having a hydrolyzable functional group or a condensable functional group, and a hydrolysis product of the polysiloxane compound having a hydrolyzable functional group.

The polysiloxane compound having a hydrolyzable functional group or a condensable functional group may further have a reactivity group different from the hydrolyzable functional group and the condensable functional group (functional group that corresponds neither to the hydrolyzable functional group nor to the condensable functional group). Examples of the reactivity group include, but are not particularly limited to, an epoxy group, a mercapto group, a glycidoxy group, a vinyl group, an acryloyl group, a methacryloyl group and an amino group. The epoxy group may be included in an epoxy group-containing group such as a glycidoxy group. The polysiloxane compound having the reactivity group may be used alone or by mixing two or more types.

Examples of the polysiloxane compound having a hydroxyalkyl group include a compound having a structure represented by the following formula (A).

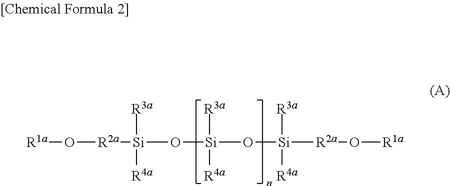

In the formula (A), R^{1a} represents a hydroxyalkyl group, R^{2a} represents an alkylene group, R^{3a} and R^{4a} each independently represent an alkyl group or an aryl group, and n represents an integer of 1 to 50. In this context, examples of the aryl group include a phenyl group and a substituted phenyl group. Examples of the substituent of the substituted phenyl group include alkyl groups, a vinyl group, a mercapto group, an amino group, a nitro group and a cyano group. In the formula (A), two R^{1a} may be the same as or different from each other, and likewise, two R^{2a} may be the same as or different from each other. In the formula (A), two or more R^{3a} may be the same as or different from each other, and likewise, two or more R^{4a} may be the same as or different from each other.

Aerogel that has low thermal conductivity and is flexible is more easily obtained by using wet gel being a condensate of sol (wet gel produced from the sol) containing a polysiloxane compound having the structure described above. From a similar viewpoint, features given below may be satisfied. In the formula (A), examples of R^{1a} include hydroxyalkyl groups having 1 to 6 carbon atoms and specifically include a hydroxyethyl group and a hydroxypropyl group. In the formula (A), examples of R^{2a} include alkylene groups having 1 to 6 carbon atoms and specifically include an ethylene group and a propylene group. In the formula (A), R^{3a} and R^{4a} may each independently be an alkyl group having 1 to 6 carbon atoms or a phenyl group. The alkyl group may be a methyl group. In the formula (A), n may be 2 to 30 and may be 5 to 20.

A commercially available product can be used as the polysiloxane compound having a structure represented by the above formula (A), and examples thereof include compounds such as X-22-160AS, KF-6001, KF-6002, and KF-6003 (all manufactured by Shin-Etsu Chemical Co., Ltd.), and compounds such as XF42-B0970 and Fluid OFOH 702-4% (all manufactured by Momentive Performance Materials Inc.).

Examples of the polysiloxane compound having an alkoxy group include a compound having a structure represented by the following formula (B).

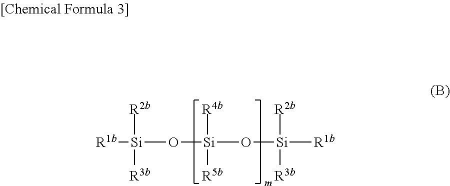

In the formula (B), R^{1b} represents an alkyl group, an alkoxy group or an aryl group, R^{2b} and R^{3b} each independently represent an alkoxy group, R^{4b} and R^{5b} each independently represent an alkyl group or an aryl group, and m represents an integer of 1 to 50. In this context, examples of the aryl group include a phenyl group and a substituted phenyl group. Examples of the substituent of the substituted phenyl group include alkyl groups, a vinyl group, a mercapto group, an amino group, a nitro group and a cyano group. In the formula (B), two R^{1b} may be the same as or different from each other, two R^{2b} may be the same as or different from each other, and likewise, two R^{3b} may be the same as or different from each other. In the formula (B), in the case where m is an integer of 2 or larger, two or more R^{4b} may be the same as or different from each other, and likewise, two or more R^{5b} may be the same as or different from each other.

Aerogel that has low thermal conductivity and is flexible is more easily obtained by using wet gel being a condensate of sol (wet gel produced from the sol) containing a polysiloxane compound having the structure described above or a hydrolysis product thereof. From a similar viewpoint, features given below may be satisfied. In the formula (B), examples of R^{1b} include alkyl groups having 1 to 6 carbon atoms and alkoxy groups having 1 to 6 carbon atoms and specifically include a methyl group, a methoxy group and an ethoxy group. In the formula (B), R^{2b} and R^{3b} may each independently be an alkoxy group having 1 to 6 carbon atoms. Examples of the alkoxy group include a methoxy group and an ethoxy group. In the formula (B), R^{4b} and R^{5b} may each independently be an alkyl group having 1 to 6 carbon atoms or a phenyl group. The alkyl group may be a methyl group. In the formula (B), m may be 2 to 30 and may be 5 to 20.

The polysiloxane compound having a structure represented by the above formula (B) can be obtained by appropriately referring to manufacturing methods reported in, for example, Japanese Unexamined Patent Publication No. 2000-26609 and Japanese Unexamined Patent Publication No. 2012-233110.

Since an alkoxy group hydrolyzes, there is a possibility that a polysiloxane compound having an alkoxy group exists as a hydrolysis product in sol, and the polysiloxane compound having an alkoxy group and a hydrolysis product thereof may coexist. Also, in the polysiloxane compound having an alkoxy group, all alkoxy groups in the molecule may be hydrolyzed or may be partially hydrolyzed.

Each of the polysiloxane compound having a hydrolyzable functional group or a condensable functional group, and the hydrolysis product of the polysiloxane compound having a hydrolyzable functional group may be used alone or by mixing two or more types.

The content of the polysiloxane compound group (the sum of the content of the polysiloxane compound having a hydrolyzable functional group or a condensable functional group, and the content of the hydrolysis product of the polysiloxane compound having a hydrolyzable functional group) contained in the sol may be 1 part by mass or more, may be 3 parts by mass or more, may be 4 parts by mass or more, may be 5 parts by mass or more, may be 7 parts by mass or more, and may be 10 parts by mass or more, with respect to 100 parts by mass in total of the sol from the viewpoint of more easily obtaining good reactivity. The content of the polysiloxane compound group may be 50 parts by mass or less, may be 30 parts by mass or less, and may be 15 parts by mass or less, with respect to 100 parts by mass in total of the sol from the viewpoint of more easily obtaining good compatibility. From these viewpoints, the content of the polysiloxane compound group may be 1 to 50 parts by mass, may be 3 to 50 parts by mass, may be 4 to 50 parts by mass, may be 5 to 50 parts by mass, may be 7 to 30 parts by mass, may be 10 to 30 parts by mass, and may be 10 to 15 parts by mass, with respect to 100 parts by mass in total of the sol.

[Second Aspect]

A silicon compound other than the polysiloxane compound may be used as the silicon compound having a hydrolyzable functional group or a condensable functional group. Specifically, the aerogel according to the present embodiment may be a dried product of wet gel being a condensate of sol containing at least one compound selected from the group consisting of a silicon compound (except for the polysiloxane compound) having a hydrolyzable functional group or a condensable functional group (in the molecule), and a hydrolysis product of the silicon compound having a hydrolyzable functional group (hereinafter, referred to as the “silicon compound group” in some cases). The number of silicon atoms in the molecule of the silicon compound may be 1 or 2.

Examples of the silicon compound having a hydrolyzable functional group include, but are not particularly limited to, alkyl silicon alkoxides. In the alkyl silicon alkoxide, the number of the hydrolyzable functional group may be 3 or less and may be 2 to 3, from the viewpoint that water resistance improves. Examples of the alkyl silicon alkoxides include monoalkyltrialkoxysilanes, monoalkyldialkoxysilanes, dialkyldialkoxysilanes, monoalkylmonoalkoxysilanes, dialkylmonoalkoxysilanes and trialkylmonoalkoxysilanes. Examples of the alkyl silicon alkoxide include methyltrimethoxysilane, methyldimethoxysilane, dimethyldimethoxysilane and ethyltrimethoxysilane.

Examples of the silicon compound having a condensable functional group include, but are not particularly limited to, silanetetraol, methylsilanetriol, dimethylsilanediol, phenylsilanetriol, phenylmethylsilanediol, diphenylsilanediol, n-propylsilanetriol, hexylsilanetriol, octylsilanetriol, decylsilanetriol and trifluoropropylsilanetriol.

Vminyltrimethoxysilane, 3-glycidoxypropyltrimethoxysilane, 3-glycidoxypropylmethyldimethoxysilane, 3-methacryloxypropyltrimethoxysilane, 3-methacryloxypropylmethyldimethoxysilane, 3-acryloxypropyltrimethoxysilane, 3-mercaptopropyltrimethoxysilane, 3-mercaptopropylmethyldimethoxysilane, N-phenyl-3-aminopropyltrimethoxysilane, N-2-(aminoethyl)-3-aminopropylmethyldimethoxysilane or the like can also be used as the silicon compound having three or less hydrolyzable functional groups and having a reactivity group.

Vinylsilanetriol, 3-glycidoxypropylsilanetriol, 3-glycidoxypropylmethylsilanediol, 3-methacryloxypropylsilanetriol, 3-methacryloxypropylmethylsilanediol, 3-acryloxypropylsilanetriol, 3-mercaptopropylsilanetriol, 3-mercaptopropylmethylsilanediol, N-phenyl-3-aminopropylsilanetriol, N-2-(aminoethyl)-3-aminopropylmethylsilanediol or the like can also be used as the silicon compound having a condensable functional group and having the reactivity group mentioned above.

Bistrimethoxysilyhnethane, bistrimethoxysilylethane, bistrimethoxysilylhexane or the like, which is a silicon compound having more than 3 hydrolyzable functional groups at the molecular end, can also be used as the alkyl silicon alkoxide.

Each of the silicon compound (except for the polysiloxane compound) having a hydrolyzable functional group or a condensable functional group, and the hydrolysis product of the silicon compound having a hydrolyzable functional group may be used alone or by mixing two or more types.

The content of the silicon compound group (the sum of the content of the silicon compound (except for the polysiloxane compound) having a hydrolyzable functional group or a condensable functional group, and the content of the hydrolysis product of the silicon compound having a hydrolyzable functional group) contained in the sol can be 5 parts by mass or more, may be 10 parts by mass or more, may be 12 parts by mass or more, may be 15 parts by mass or more, and may be 18 parts by mass or more, with respect to 100 parts by mass in total of the sol because of more easily obtaining good reactivity. The content of the silicon compound group can be 50 parts by mass or less, may be 30 parts by mass or less, may be 25 parts by mass or less, and may be 20 parts by mass or less, with respect to 100 parts by mass in total of the sol because of more easily obtaining good compatibility. Specifically, the content of the silicon compound group can be 5 to 50 parts by mass, may be 10 to 30 parts by mass, may be 12 to 30 parts by mass, may be 15 to 25 parts by mass, and may be 18 to 20 parts by mass, with respect to 100 parts by mass in total of the sol.

The sum of the content of the polysiloxane compound group and the content of the silicon compound group may be 5 parts by mass or more, may be 10 parts by mass or more, may be 15 parts by mass or more, may be 20 parts by mass or more, and may be 22 parts by mass or more, with respect to 100 parts by mass in total of the sol from the viewpoint of more easily obtaining good reactivity. The sum of the content of the polysiloxane compound group and the content of the silicon compound group may be 50 parts by mass or less, may be 30 parts by mass or less, and may be 25 parts by mass or less, with respect to 100 parts by mass in total of the sol from the viewpoint of more easily obtaining good compatibility. From these viewpoints, the sum of the content of the polysiloxane compound group and the content of the silicon compound group may be 5 to 50 parts by mass, may be 10 to 30 parts by mass, may be 15 to 30 parts by mass, may be 20 to 30 parts by mass, and may be 22 to 25 parts by mass, with respect to 100 parts by mass in total of the sol.

The ratio between the content of the polysiloxane compound group and the content of the silicon compound group (polysiloxane compound group:silicon compound group) may be 1:0.5 or more, may be 1:1 or more, may be 1:2 or more, and may be 1:3 or more, from the viewpoint of more easily obtaining good compatibility. The ratio between the content of the polysiloxane compound group and the content of the silicon compound group (polysiloxane compound group:silicon compound group) may be 1:4 or less and may be 1:2 or less, from the viewpoint of more easily suppressing the shrinkage of gel. From these viewpoints, the ratio between the content of the polysiloxane compound group and the content of the silicon compound group (polysiloxane compound group:silicon compound group) may be 1:0.5 to 1:4, may be 1:1 to 1:2, may be 1:2 to 1:4, and may be 1:3 to 1:4.

[Third Aspect]

The aerogel according to the present embodiment can have a structure represented by the following formula (1). The aerogel according to the present embodiment can have a structure represented by the following formula (1a) as a structure including the structure represented by the formula (1). The structures represented by the formula (1) and the formula (1a) can be introduced into the skeleton of the aerogel by using the polysiloxane compound having a structure represented by the above formula (A).

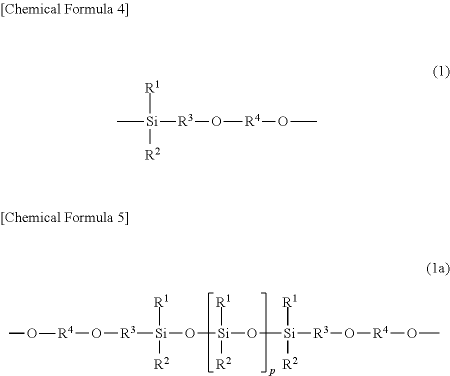

In the formula (1) and the formula (1a), R¹ and R² each independently represent an alkyl group or an aryl group, and R³ and R⁴ each independently represent an alkylene group. In this context, examples of the aryl group include a phenyl group and a substituted phenyl group. Examples of the substituent of the substituted phenyl group include alkyl groups, a vinyl group, a mercapto group, an amino group, a nitro group and a cyano group. p represents an integer of 1 to 50. In the formula (1a), two or more R¹ may be the same as or different from each other, and likewise, two or more R² may be the same as or different from each other. In the formula (1a), two R³ may be the same as or different from each other, and likewise, two R⁴ may be the same as or different from each other.

Aerogel that has low thermal conductivity and is flexible can be easily obtained by introducing the structure represented by the above formula (1) or formula (1a) into the skeleton of the aerogel. From a similar viewpoint, features given below may be satisfied. In the formula (1) and the formula (1a), R¹ and R² may each independently be an alkyl group having 1 to 6 carbon atoms or a phenyl group. The alkyl group may be a methyl group. In the formula (1) and the formula (1a), R³ and R⁴ may each independently be an alkylene group having 1 to 6 carbon atoms. The alkylene group may be an ethylene group or a propylene group. In the formula (1a), p can be set to 2 to 30 and may be 5 to 20.

[Fourth Aspect]

The aerogel according to the present embodiment may be aerogel having a ladder-type structure having struts and bridges, wherein the bridges have a structure represented by the following formula (2). Heat resistance and mechanical strength can be easily improved by introducing such a ladder-type structure into the skeleton of the aerogel. The ladder-type structure including the bridges having a structure represented by the formula (2) can be introduced into the skeleton of the aerogel by using the polysiloxane compound having a structure represented by the above formula (B). In the present embodiment, the “ladder-type structure” is a structure having two struts and bridges connecting the struts (structure having the form of a so-called “ladder”). In this aspect, the aerogel skeleton may consist of a ladder-type structure, or the aerogel may partially have a ladder-type structure.

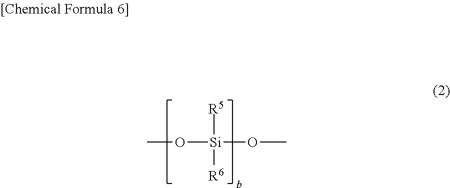

In the formula (2), R⁵ and R⁶ each independently represent an alkyl group or an aryl group, and b represents an integer of 1 to 50. In this context, examples of the aryl group include a phenyl group and a substituted phenyl group. Examples of the substituent of the substituted phenyl group include alkyl groups, a vinyl group, a mercapto group, an amino group, a nitro group and a cyano group. In the formula (2), in the case where b is an integer of 2 or larger, two or more R⁵ may be the same as or different from each other, and likewise, two or more R⁶ may be the same as or different from each other.

For example, aerogel having better flexibility than that of conventional aerogel having a structure derived from ladder-type silsesquioxane (i.e., having a structure represented by the following formula (X)) is prepared by introducing the structure described above into the skeleton of the aerogel. As shown in the following formula (X), the structure of the bridges in the conventional aerogel having a structure derived from ladder-type silsesquioxane is —O—, whereas the structure of the bridges in the aerogel of this aspect is a structure represented by the above formula (2) (polysiloxane structure).

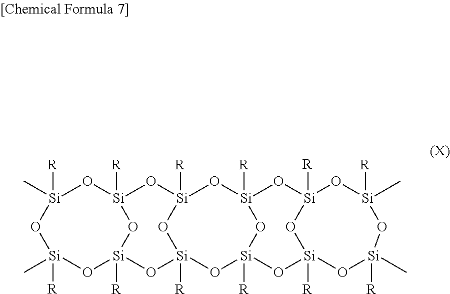

In the formula (X), R represents a hydroxy group, an alkyl group or an aryl group.

Although the structures serving as the struts and the chain length thereof, and the intervals between the structures serving as the bridges are not particularly limited, a ladder-type structure represented by the following formula (3) may be contained as the ladder-type structure from the viewpoint of further improving heat resistance and mechanical strength.

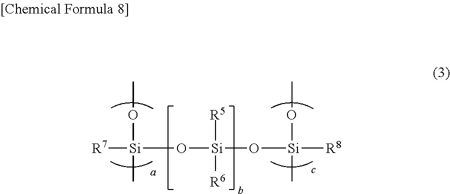

In the formula (3), R⁵, R⁶, R⁷ and R⁸ each independently represent an alkyl group or an aryl group, a and c each independently represent an integer of 1 to 3000, and b represents an integer of 1 to 50. In this context, examples of the aryl group include a phenyl group and a substituted phenyl group. Examples of the substituent of the substituted phenyl group include alkyl groups, a vinyl group, a mercapto group, an amino group, a nitro group and a cyano group. In the formula (3), in the case where b is an integer of 2 or larger, two or more R⁵ may be the same as or different from each other, and likewise, two or more R⁶ may be the same as or different from each other. In the formula (3), in the case where a is an integer of 2 or larger, two or more R⁷ may be the same as or different from each other. In the formula (3), in the case where c is an integer of 2 or larger, two or more R⁸ may be the same as or different from each other.

In the formula (2) and the formula (3), R⁵, R⁶, R⁷ and R⁸ (however, R⁷ and R⁸ are only in the formula (3)) may each independently be an alkyl group having 1 to 6 carbon atoms or a phenyl group from the viewpoint of obtaining much better flexibility. The alkyl group may be a methyl group. In the formula (3), a and c may each independently be 6 to 2000 and may each independently be 10 to 1000. In the formula (2) and the formula (3), b may be 2 to 30 and may be 5 to 20.

[Fifth Aspect]

The aerogel according to the present embodiment may contain silica particles from the viewpoint of further strengthening the thermal insulating layer and from the viewpoint of achieving much better thermal insulation properties and flexibility. The sol that yields the aerogel may further contain silica particles. Specifically, the aerogel according to the present embodiment may be a dried product of wet gel being a condensate of sol (one obtained by drying wet gel produced from the sol) containing silica particles. The aerogel layer may be a layer constituted by a dried product of wet gel being a condensate of sol containing silica particles. Specifically, the aerogel layer may be constituted by a layer prepared by drying wet gel produced from sol containing silica particles. Specifically, the thermal insulating layer may be an aerogel layer constituted by a dried product of wet gel being a condensate of sol containing silica particles, or may be constituted by an aerogel layer prepared by drying wet gel produced from sol containing silica particles. The aerogel mentioned above may also be such a dried product of wet gel being a condensate of sol (one obtained by drying wet gel produced from the sol) containing silica particles.

The silica particles can be used without particular limitations, and examples thereof include amorphous silica particles. Examples of the amorphous silica particles include fused silica particles, fumed silica particles and colloidal silica particles. Among these, the colloidal silica particles are highly monodisperse and are easily prevented from aggregating in the sol.

Examples of the shape of the silica particles include, but are not particularly limited to, a spherical shape, cocoon type, and associated type. Among these, spherical particles are used as the silica particles and are thereby easily prevented from aggregating in the sol. The average primary particle diameter of the silica particles may be 1 nm or larger, may be 5 nm or larger, may be 10 nm or larger, and may be 20 nm or larger, from the viewpoint of easily imparting moderate strength to the aerogel and easily obtaining aerogel excellent in shrinkage resistance at the time of drying. The average primary particle diameter of the silica particles may be 500 nm or smaller, may be 300 nm or smaller, may be 250 nm or smaller, and may be 100 nm or smaller, from the viewpoint of easily suppressing the solid heat conduction of the silica particles and easily obtaining aerogel excellent in thermal insulation properties. From these viewpoints, the average primary particle diameter of the silica particles may be 1 to 500 nm, may be 5 to 300 nm, may be 10 to 250 nm, and may be 20 to 100 nm.

In the present embodiment, the average particle diameter of particles (the average primary particle diameter of the silica particles, etc.) can be obtained by directly observing the cross-section of the thermal insulating layer under a scanning electron microscope (hereinafter, abbreviated to “SEM”). For example, from the network microstructure in the inside of the aerogel, the individual particle diameters of the aerogel particles or the silica particles can be obtained on the basis of the diameters of particles exposed on the cross-section of the thermal insulating layer. In this context, the “diameter” means a diameter in the case of regarding the cross-section of a particle exposed on the cross-section of the thermal insulating layer as a circle. Also, the “diameter in the case of regarding the cross-section as a circle” is the diameter of a true circle when the area of the cross-section is replaced with the true circle having the same area. For the calculation of the average particle diameter, the diameter of a circle is determined as to 100 particles, and the average thereof is taken.

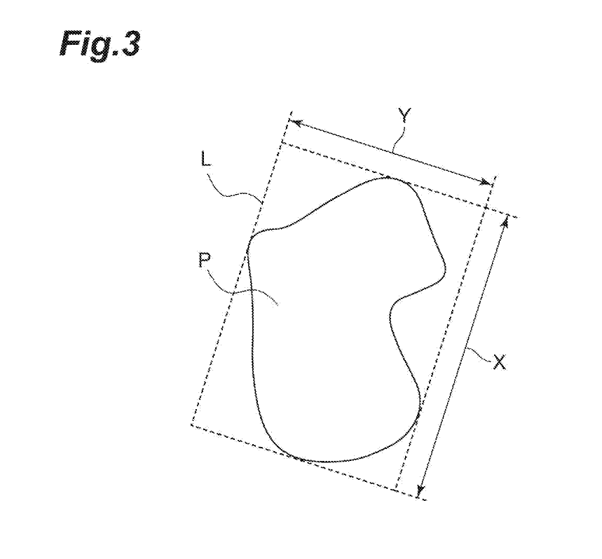

The average particle diameter of the silica particles can be measured from the raw material. For example, the two-axis average primary particle diameter is calculated as follows from results of observing 20 arbitrary particles by SEM. Specifically, when colloidal silica particles having a solid concentration of 5 to 40% by mass, which are usually dispersed in water, are taken as an example, a chip obtained by cutting a patterned wafer into 2 cm square is dipped in the dispersion of the colloidal silica particles for approximately 30 seconds, and then, the chip is rinsed with pure water for approximately 30 seconds and dried by nitrogen blow. Then, the chip is placed on a sample table for SEM observation, and the silica particles are observed at a magnification of ×100000 by applying accelerating voltage of 10 kV, followed by photographing. Twenty silica particles are arbitrarily selected from the obtained image, and the average of the particle diameters of these particles is regarded as the average particle diameter. In this respect, in the case where the selected silica particles have a shape as shown in FIG. 3, a rectangle that circumscribes silica particle P and is positioned such that its long side becomes longest (bounding rectangle L) is drawn. Then, when the long side of the bounding rectangle L is defined as X, and the short side is defined as Y, the two-axis average primary particle diameter is calculated as (X+Y)/2 and regarded as the particle diameter of the particle.

The number of silanol groups per g of the silica particles may be 10×10¹⁸ groups/g or more, may be 50×10¹⁸ groups/g or more, and may be 100×10¹⁸ groups/g or more, from the viewpoint of easily obtaining aerogel excellent in shrinkage resistance. The number of silanol groups per g of the silica particles may be 1000×10¹⁸ groups/g or less, may be 800×10¹⁸ groups/g or less, and may be 700×10¹⁸ groups/g or less, from the viewpoint that homogeneous aerogel is easily obtained. From these viewpoints, the number of silanol groups per g of the silica particles may be 10×10¹⁸ to 1000×10¹⁸ groups/g, may be 50×10¹⁸ to 800×10¹⁸ groups/g, and may be 100×10¹⁸ to 700×10¹⁸ groups/g.

The content of the silica particles contained in the sol may be 1 part by mass or more and may be 4 parts by mass or more, with respect to 100 parts by mass in total of the sol from the viewpoint of easily imparting moderate strength to the aerogel and easily obtaining aerogel excellent in shrinkage resistance at the time of drying. The content of the silica particles contained in the sol may be 20 parts by mass or less, may be 15 parts by mass or less, may be 12 parts by mass or less, may be 10 parts by mass or less, and may be 8 parts by mass or less, with respect to 100 parts by mass in total of the sol from the viewpoint of easily suppressing the solid heat conduction of the silica particles and easily obtaining aerogel excellent in thermal insulation properties. From these viewpoints, the content of the silica particles contained in the sol may be 1 to 20 parts by mass, may be 4 to 15 parts by mass, may be 4 to 12 parts by mass, may be 4 to 10 parts by mass, and may be 4 to 8 parts by mass, with respect to 100 parts by mass in total of the sol.

[Other Aspects]

The aerogel according to the present embodiment can have a structure represented by the following formula (4). The aerogel according to the present embodiment can contain silica particles and also have a structure represented by the following formula (4).

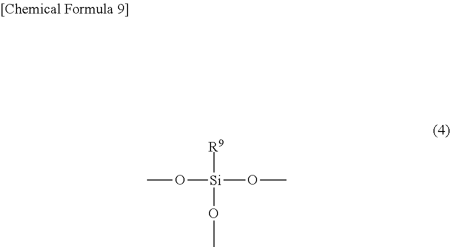

In the formula (4), R⁹ represents an alkyl group. Examples of the alkyl group include alkyl groups having 1 to 6 carbon atoms and specifically include a methyl group.

The aerogel according to the present embodiment can have a structure represented by the following formula (5). The aerogel according to the present embodiment can contain silica particles and also have a structure represented by the following formula (5).

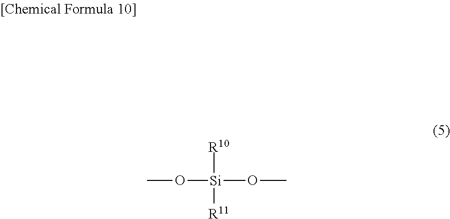

In the formula (5), R¹⁰ and R¹¹ each independently represent an alkyl group. Examples of the alkyl group include alkyl groups having 1 to 6 carbon atoms and specifically include a methyl group.

The aerogel according to the present embodiment can have a structure represented by the following formula (6). The aerogel according to the present embodiment can contain silica particles and also have a structure represented by the following formula (6).

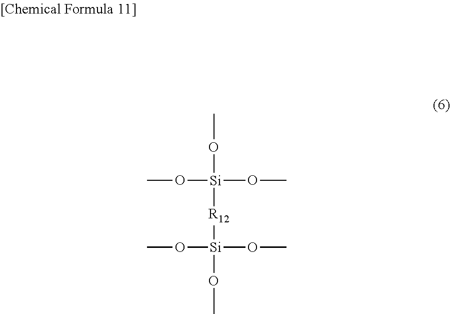

In the formula (6), R¹² represents an alkylene group. Examples of the alkylene group include alkylene groups having 1 to 10 carbon atoms and specifically include an ethylene group and a hexylene group.

The aerogel according to the present embodiment may have a polysiloxane-derived structure. Examples of the polysiloxane-derived structure include a structure represented by the above formula (1), (2), (3), (4), (5) or (6). The aerogel according to the present embodiment may have at least one of the structures represented by the above formulas (4), (5) and (6) without containing silica particles.

The thickness of the thermal insulating layer may be 1 μm or larger, may be 10 μm or larger, and may be 30 μm or larger, because of easily obtaining good thermal insulation properties. The thickness of the thermal insulating layer may be 1000 μm or smaller, may be 500 μm or smaller, and may be 250 μm or smaller, from the viewpoint that the times of a washing and solvent replacement step and a drying step mentioned later can be shortened. From these viewpoints, the thickness of the thermal insulating layer may be 1 to 1000 μm, may be 10 to 500 μm, and may be 30 to 250 μm.

<Method for Manufacturing Thermally Insulated Body>

Next, the method for manufacturing a thermally insulated body will be described.

The method for manufacturing a thermally insulated body according to the present embodiment is a method for manufacturing a thermally insulated body comprising a thermal insulating layer integrally formed with a thermal insulation object, the method comprising a step of applying sol to the thermal insulation object and forming a thermal insulating layer including aerogel from the sol. In this context, aspects regarding the thermal insulation object, the thermal insulating layer, the sol and the aerogel are as mentioned above.

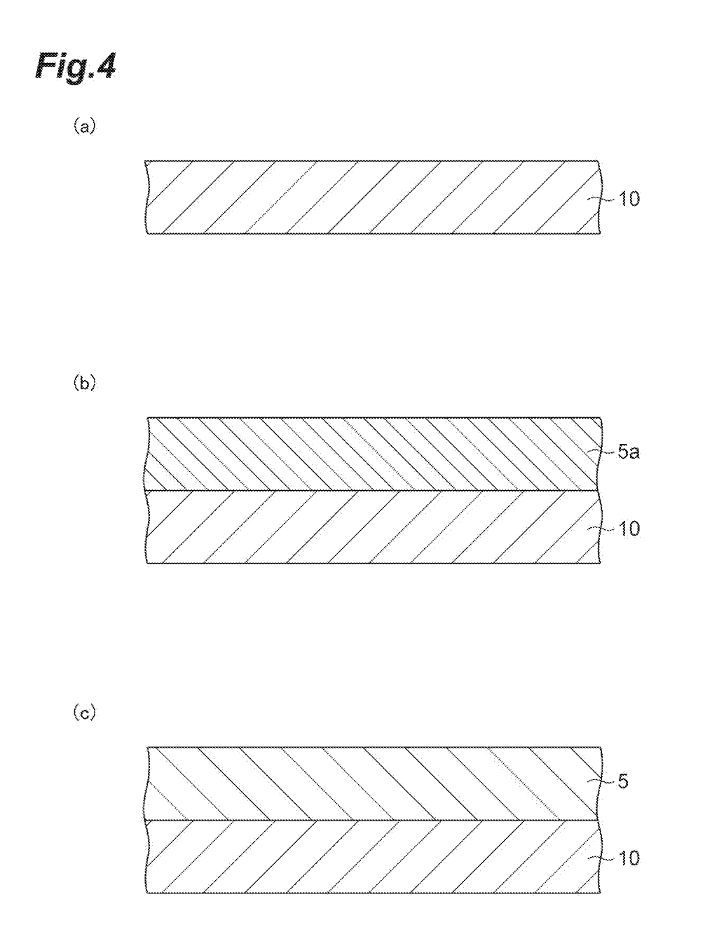

Specifically, for example, as shown in FIG. 4, after a thermal insulation object 10 is provided (FIG. 4(a)), sol (also referred to as a “sol coating liquid”) 5a is applied to the thermal insulation object 10 (FIG. 4(b)), and a thermal insulating layer 5 including aerogel is formed from the sol 5a (FIG. 4(c)). In the case where the thermal insulation object is only a main body part, after the main body part is provided, sol is directly applied to the main body part, and a thermal insulating layer including aerogel can be formed from the sol.

According to the method for manufacturing a thermally insulated body according to the present embodiment, a thermally insulated body having excellent thermal insulation properties can be manufactured. Also, according to the manufacturing method, a thermally insulated body having excellent flame retardance and heat resistance can be manufactured while the falling of the aerogel can be suppressed. According to the manufacturing method, the thermal insulating layer including aerogel can be integrally formed with the thermal insulation object. Thus, the thermally insulated body manufactured by the manufacturing method easily prevents the thermal insulating layer from being detached from the thermal insulation object and can have a stable thermal insulation effect.

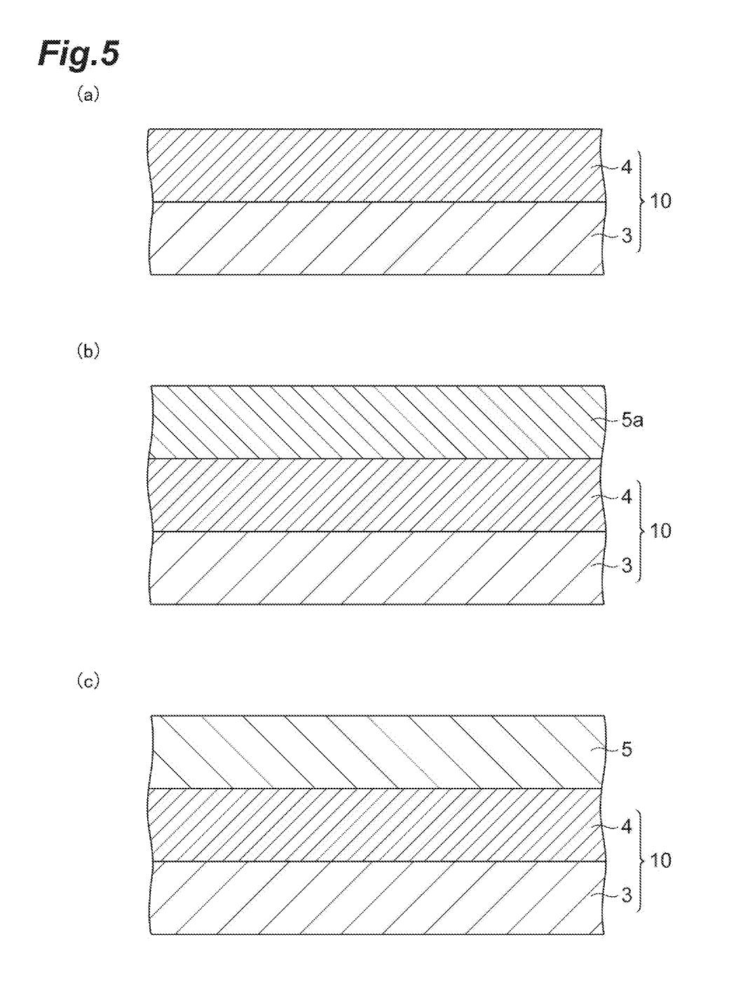

In the method for manufacturing a thermally insulated body according to the present embodiment, the thermal insulation object may have a main body part and a covering layer covering at least a portion of a surface of the main body part, and the sol may be applied onto at least the covering layer such that the covering layer becomes an intermediate layer. Specifically, in the case where the thermal insulation object has a main body part and a covering layer, for example, as shown in FIG. 5, after a thermal insulation object 10 having a main body part 3 and a covering layer 4 is provided (FIG. 5(a)), sol 5a is applied onto the covering layer 4 such that the covering layer 4 becomes an intermediate layer (FIG. 5(b)), and a thermal insulating layer 5 including aerogel is formed from the sol 5a (FIG. 5(c)). According to such a method, the bonding strength and adhesion between the main body part and the thermal insulating layer improve, and the falling of the thermal insulating layer is further suppressed. Also, by this, a thermally insulated body excellent in the storage stability of the main body part can be manufactured because a thermal insulation effect can be stably obtained. Aspects regarding the main body part and the covering layer are as mentioned above.

Hereinafter, specific examples of the method for manufacturing a thermally insulated body according to the present embodiment will be described in more detail. However, the method for manufacturing a thermally insulated body is not limited to the following methods.

The thermally insulated body according to the present embodiment can be manufactured, for example, by a manufacturing method mainly comprising: a provision step of providing a thermal insulation object; a sol production step of preparing sol for forming aerogel; a contact step of contacting the sol obtained in the sol production step with the thermal insulation object, followed by drying so that a thermal insulating layer integrally joined with the thermal insulation object is formed to obtain a thermally insulated body; an aging step of aging the thermally insulated body obtained in the contact step; a step of subjecting the aged thermally insulated body to washing and solvent replacement; and a drying step of drying the washed and (if necessary) solvent-replaced thermally insulated body. The “sol” refers to a state before gelling reaction occurs. In the present embodiment, it means, for example, a state where a silicon compound (if necessary, further, silica particles) is dissolved or dispersed in a solvent.

Hereinafter, each step will be described.

{Provision Step}

In the provision step, for example, a main body part or a main body part with a covering layer formed is provided. The covering layer can be formed, for example, by a covering layer formation step of forming the covering layer on the main body part.

(Covering Layer Formation Step)

The covering layer formation step is, for example, a step of contacting a composition for covering layer formation with a base material serving as the main body part to form the covering layer on the main body part. Specifically, for example, the covering layer is formed on the surface of a base material by contacting a composition for covering layer formation with the base material, if necessary followed by heating and drying. The composition for covering layer formation may be a liquid composition such as a primer liquid, or may be a sheet-shaped composition such as a pressure-sensitive adhesive sheet.

The contacting method is appropriately selected according to the type of the composition for covering layer formation, the thickness of the covering layer, or the shape of the base material. In the case where the composition for covering layer formation is a sheet-shaped composition, for example, a method of lamination on the base material can be used, and in the case where the composition for covering layer formation is a liquid composition, for example, dip coating, spray coating, spin coating, or roll coating can be used.

The contacting method is selected from the viewpoint of film formability or manufacturing cost. Dip coating or roll coating can be used for, for example, a sheet-shaped, a plate-shaped or fibrous base material. Dip coating or spray coating can be used for a base material in a block form or having a curved surface (e.g., spherical in shape).

In the covering layer formation step, heat treatment may be performed from the viewpoint of drying and fixing the composition for covering layer formation, and washing and/or drying may be performed from the viewpoint of removing impurities and from the viewpoint of improving the adhesion of the covering layer. Also, the covering layer surface may be subjected to polishing treatment and/or roughening treatment for the purpose of adjusting the surface roughness of the covering layer.

{Sol Production Step}

The sol production step is, for example, a step of mixing a silicon compound (if necessary, further, silica particles) with a solvent, performing hydrolysis reaction, and then performing sol-gel reaction to obtain a semi-gelled sol coating liquid. In the sol production step, an acid catalyst may be further added into the solvent in order to accelerate the hydrolysis reaction. Also, as shown in Japanese Patent No. 5250900, a surfactant, a thermally hydrolyzable compound or the like can also be added into the solvent. Further, a base catalyst may be added in order to accelerate the gelling reaction. In the case where the thermal insulating layer contains an inorganic fibrous substance, the inorganic fibrous substance may be added in this step. Silica particles may be contained in the sol from the viewpoint of shortening the process times of the sol production step, the contact step and the aging step and lowering heating temperature and drying temperature.

The solvent is not particularly limited as long as good film performance is obtained in the contact step, and, for example, water or a mixed solution of water and an alcohol can be used. Examples of the alcohol include methanol, ethanol, n-propanol, 2-propanol, n-butanol, 2-butanol and t-butanol. Among these, water can be used from the viewpoint that surface tension is high, and volatility is low.

Examples of the acid catalyst include: inorganic acids such as hydrofluoric acid, hydrochloric acid, nitric acid, sulfuric acid, sulfurous acid, phosphoric acid, phosphorous acid, hypophosphorous acid, bromic acid, chloric acid, chlorous acid, and hypochlorous acid; acidic phosphates such as acidic aluminum phosphate, acidic magnesium phosphate, and acidic zinc phosphate; and organic carboxylic acids such as acetic acid, formic acid, propionic acid, oxalic acid, malonic acid, succinic acid, citric acid, malic acid, adipic acid, and azelaic acid. Among these, an organic carboxylic acid can be used as the acid catalyst from the viewpoint that the water resistance of the resulting thermally insulated body further improves, and is specifically acetic acid, formic acid, propionic acid, oxalic acid, or malonic acid and may be acetic acid. The acid catalyst may be used alone or by mixing two or more types.

The sol can be obtained in a shorter time by using the acid catalyst and thereby accelerating the hydrolysis reaction of the silicon compound.

The amount of the acid catalyst added may be 0.001 to 0.1 parts by mass with respect to 100 parts by mass in total of the silicon compound.

A nonionic surfactant, an ionic surfactant or the like can be used as the surfactant. The surfactant may be used alone or by mixing two or more types.

For example, one including a hydrophilic moiety such as polyoxyethylene and a hydrophobic moiety consisting mainly of an alkyl group, or one including a hydrophilic moiety such as polyoxypropylene can be used as the nonionic surfactant. Examples of the one including a hydrophilic moiety such as polyoxyethylene and a hydrophobic moiety consisting mainly of an alkyl group include polyoxyethylene nonyl phenyl ether, polyoxyethylene octyl phenyl ether, and polyoxyethylene alkyl ethers. Examples of the one including a hydrophilic moiety such as polyoxypropylene include polyoxypropylene alkyl ethers and block copolymers of polyoxyethylene and polyoxypropylene.

A cationic surfactant, an anionic surfactant, an amphoteric surfactant or the like can be used as the ionic surfactant, and a cationic surfactant or an anionic surfactant may be used. Examples of the cationic surfactant include cetyl trimethyl ammonium bromide (CTAB) and cetyl trimethyl ammonium chloride. Examples of the anionic surfactant include sodium dodecylsulfonate. Examples of the amphoteric surfactant include amino acid-based surfactants and betaine-based surfactants and amine oxide-based surfactants. Examples of the amino acid-based surfactants include acylglutamic acid. Examples of the betaine-based surfactants include lauryl dimethylaminoacetic acid betaine and stearyl dimethylaminoacetic acid betaine. Examples of the amine oxide-based surfactants include lauryl dimethylamine oxide.

These surfactants are considered, in the contact step, to have the effect of decreasing the difference in chemical affinity between the solvent in the reaction system and a growing siloxane polymer, and suppressing phase separation.

The amount of the surfactant added may be, for example, 1 to 100 parts by mass and may be 5 to 60 parts by mass, with respect to 100 parts by mass in total of the silicon compound, though also depending on the type of the surfactant, or the type and amount of the silicon compound.

The thermally hydrolyzable compound generates a base catalyst by thermal hydrolysis so that the reaction solution is rendered basic to accelerate the sol-gel reaction. The thermally hydrolyzable compound is not particularly limited as long as being a compound that can render the reaction solution basic after hydrolysis, and examples thereof can include: urea; acid amides such as formamide, N-methylformamide, N,N-dimethylformamide, acetamide, N-methylacetamide, and N,N-dimethylacetamide, and cyclic nitrogen compounds such as hexamethylenetetramine. Among these, particularly, urea is more likely to produce the accelerating effect described above.

The amount of the thermally hydrolyzable compound added is not particularly limited as long as being an amount that can sufficiently accelerate the sol-gel reaction. For example, the amount of the thermally hydrolyzable compound (urea, etc.) added may be 1 to 200 parts by mass and may be 2 to 150 parts by mass, with respect to 100 parts by mass in total of the silicon compound. The amount of the thermally hydrolyzable compound (urea, etc.) added is 1 part by mass or more, whereby good reactivity is more easily obtained; and it is 200 parts by mass or less, whereby the deposition of crystals and decrease in gel density are more easily suppressed.

The hydrolysis in the sol production step may be performed, for example, for 10 minutes to 24 hours in a temperature environment of 20 to 60° C., and may be performed for 5 minutes to 8 hours in a temperature environment of 50 to 60° C., though also depending on the types and amounts of the silicon compound, the silica particles, the acid catalyst, the surfactant, etc. in the mixed solution. By this, the hydrolyzable functional group in the silicon compound is sufficiently hydrolyzed so that a hydrolysis product of the silicon compound can be more reliably obtained.

In the case of adding the thermally hydrolyzable compound into the solvent, the temperature environment in the sol production step may be adjusted to a temperature that suppresses the hydrolysis of the thermally hydrolyzable compound and suppresses the gelling of the sol. The temperature at this time may be any temperature as long as being a temperature that can suppress the hydrolysis of the thermally hydrolyzable compound. For example, the temperature environment (e.g., the temperature environment in the case of using urea as the thermally hydrolyzable compound) in the sol production step may be 0 to 40° C. and may be 10 to 30° C.

Examples of the base catalyst include: alkali metal hydroxides such as lithium hydroxide, sodium hydroxide, potassium hydroxide, and cesium hydroxide; ammonium compounds such as ammonium hydroxide, ammonium fluoride, ammonium chloride, and ammonium bromide; basic phosphoric acid sodium salts such as sodium metaphosphate, sodium pyrophosphate, and sodium polyphosphate; aliphatic amines such as allylamine, diallylarine, triallylamine, isopropylamine, diisopropylamine, ethylamine, diethylamine, triethylamine, 2-ethylhexylamine, 3-ethoxypropylamine, diisobutylamine, 3-(diethylamino)propylamine, di-2-ethylhexylamine, 3-(dibutylamino)propylamine, tetramethylethylenediamine, t-butylamine, sec-butylamine, propylamine, 3-(methylamino)propylamine, 3-(dimethylamino)propylamine, 3-methoxyamine, dimethylethanolamine, methyldiethanolamine, diethanolamine, and triethanolamine; and nitrogen-containing heterocyclic compounds such as morpholine, N-methylmorpholine, 2-methylmorpholine, piperazine and derivatives thereof, piperidine and derivatives thereof, and imidazole and derivatives thereof. Among these, ammonium hydroxide (ammonia water) can be used from the viewpoint of not impairing water resistance because of being highly volatile and being less likely to remain in the thermally insulated body after drying, and from the viewpoint of economic efficiency. The base catalyst may be used alone or by mixing two or more types.

The dehydration condensation reaction and/or dealcoholization condensation reaction of the silicon compound (polysiloxane compound group and silicon compound group) and the silica particles in the sol can be accelerated, and the gelling of the sol can be performed in a shorter time, by using the base catalyst. Particularly, ammonia is highly volatile and is less likely to remain in the thermally insulated body. Therefore, a thermally insulated body having much better water resistance can be obtained by using ammonia as the base catalyst.

The amount of the base catalyst added may be 0.5 to 5 parts by mass and may be 1 to 4 parts by mass, with respect to 100 parts by mass in total of the silicon compound (polysiloxane compound group and silicon compound group). The amount of the base catalyst added is 0.5 parts by mass or more, whereby the gelling can be performed in a shorter time; and it is 5 parts by mass or less, whereby reduction in water resistance can be further suppressed.

The sol-gel reaction in the sol production step can produce sol in a semi-gelled state for the purpose of obtaining good film performance in the contact step. This reaction can be performed in a closed vessel such that the solvent and the base catalyst do not volatilize. The gelling temperature may be 30 to 90° C. and may be 40 to 80° C., though also depending on the types and amounts of the silicon compound, the silica particles, the acid catalyst, the surfactant, the base catalyst, etc. in the sol. The gelling temperature is 30° C. or higher, whereby the gelling can be performed in a shorter time. The gelling temperature is 90° C. or lower, whereby abrupt gelling can be suppressed.

Although the time of the sol-gel reaction differs depending on the gelling temperature, the gelling time can be shortened in the present embodiment, as compared with sol applied to conventional aerogel, in the case of containing silica particles in the sol. The reason for this is presumed to be that the hydrolyzable functional group or the condensable functional group carried by the silicon compound in the sol forms a hydrogen bond and/or a chemical bond with the silanol groups of the silica particles. The gelling time may be 10 to 360 minutes and may be 20 to 180 minutes. The gelling time is 10 minutes or longer, whereby the viscosity of the sol improves, and good coatability is easily obtained in the contact step; and it is 360 minutes or shorter, whereby the complete gelling of the sol is suppressed, and the bonding strength with the main body part or the covering layer is easily obtained.

{Contact Step}

The contact step is a step of contacting the sol coating liquid (the sol coating liquid in a semi-gelled state, etc.) obtained in the sol production step with the main body part or the covering layer to prepare a thermally insulated body (a coating step, etc.). Specifically, the sol coating liquid is contacted with the main body part or the covering layer, and the sol coating liquid is gelled by heating and drying to form a thermal insulating layer including aerogel on the surface of the main body part or the covering layer. However, it is desirable that this thermal insulating layer should be in a state where bonding force with the main body part or the covering layer is secured.

Dip coating, spray coating, spin coating, roll coating or the like can be used as the contacting method (the coating method, etc.), and is appropriately used according to the thickness of the thermal insulating layer or the shape of the main body part. The contacting method is selected from the viewpoint of film formability or manufacturing cost. Dip coating or roll coating can be used for, for example, a sheet-shaped, a plate-shaped or fibrous main body part. Dip coating or spray coating can be used for, for example, a main body part in a block form or having a curved surface (e.g., spherical in shape).

{Aging Step}

The aging step is a step of aging the thermally insulated body obtained by the contact step, by heating. In the aging step, the water content of the thermal insulating layer after the aging may be 10% by mass or more and may be 50% by mass or more, from the viewpoint of suppressing reduction in the bonding strength between the thermal insulating layer and the main body part or the covering layer. Examples of the aging method include, but are not particularly limited to, a method of aging the thermally insulated body in a closed atmosphere, and a method of aging by using a thermo-hygrostat or the like that can suppress reduction in water content caused by heating.

The aging temperature may be, for example, 40 to 90° C. and may be 50 to 80° C. The aging temperature is 40° C. or higher, whereby the aging time can be shortened; and it is 90° C. or lower, whereby reduction in water content can be suppressed.

The aging time may be, for example, 1 to 48 hours and may be 3 to 24 hours. The aging time is 1 hour or longer, whereby excellent thermal insulation properties can be easily obtained; and it is 48 hours or shorter, whereby the high bonding strength between the thermal insulating layer and the main body part or the covering layer can be obtained.

{Washing and Solvent Replacement Step}

The washing and solvent replacement step is a step having a step of washing the thermally insulated body obtained by the aging step (washing step), and a step of replacing the solvent with a suitable one for the drying step (solvent replacement step), and approaches are not particularly limited. Although the washing and solvent replacement step may be carried out in a mode of performing only the solvent replacement step without performing the step of washing the thermally insulated body, the thermal insulating layer can be washed from the viewpoint of reducing impurities such as unreacted products and by-products in the thermal insulating layer, and permitting manufacture of a thermally insulated body having higher purity.

In the washing step, the thermally insulated body obtained in the aging step can be repetitively washed by using water or an organic solvent.

Various organic solvents such as methanol, ethanol, 1-propanol, 2-propanol, 1-butanol, acetone, methyl ethyl ketone, 1,2-dimethoxyethane, acetonitrile, hexane, toluene, diethyl ether, chloroform, ethyl acetate, tetrahydrofuran, methylene chloride, N,N-dimethylformamide, dimethyl sulfoxide, acetic acid, and formic acid can be used as the organic solvent. The organic solvent may be used alone or by mixing two or more types.

In the solvent replacement step, a solvent having low surface tension may be used for suppressing the shrinkage of the thermal insulating layer caused by drying. However, the solvent having low surface tension generally has very low mutual solubility in water. Therefore, in the case of using the solvent having low surface tension in the solvent replacement step, a hydrophilic organic solvent having high mutual solubility in both of water and the solvent having low surface tension can be used as the organic solvent used in the washing step. The hydrophilic organic solvent used in the washing step can play a role in preliminary replacement for the solvent replacement step. From this, among the organic solvents described above, methanol, ethanol, 2-propanol, acetone or methyl ethyl ketone may be used from the viewpoint of being a hydrophilic organic solvent, and methanol, ethanol or methyl ethyl ketone can be used from the viewpoint of being excellent in economic efficiency.

An amount that can sufficiently replace the solvent in the thermal insulating layer and permit washing may be used as the amount of water or the organic solvent used in the washing step, and the solvent in an amount of 3 to 10 times the volume of the thermal insulating layer can be used. The washing can be repeated until the water content in the thermal insulating layer after the washing becomes 10% by mass or less.

A temperature equal to or lower than the boiling point of the solvent used in washing can be used as the temperature environment in the washing step. In the case of using, for example, methanol, a temperature on the order of 30 to 60° C. can be used.

In the solvent replacement step, the solvent of the washed thermal insulating layer can be replaced with a predetermined solvent for replacement in order to suppress the shrinkage of the thermal insulating layer in the drying step. In this respect, replacement efficiency can be improved by warming. Specifically, in the case of drying under atmospheric pressure at a temperature lower than the critical point of the solvent used in drying in the drying step, a solvent having low surface tension mentioned later can be used as the solvent for replacement. In the case of performing supercritical drying, for example, a solvent such as ethanol, methanol, 2-propanol, dichlorodifluoromethane, or carbon dioxide can be used alone, or a mixed solvent of two or more of these can be used.

The solvent having low surface tension may be a solvent whose surface tension at 20° C. is 30 mN/m or lower, may be a solvent whose surface tension at 20° C. is 25 mN/m or lower, or may be a solvent whose surface tension at 20° C. is 20 mN/m or lower. Examples of the solvent having low surface tension include: aliphatic hydrocarbons such as pentane (15.5), hexane (18.4), heptane (20.2), octane (21.7), 2-methylpentane (17.4), 3-methylpentane (18.1), 2-methylhexane (19.3), cyclopentane (22.6), cyclohexane (25.2), and 1-pentene (16.0); aromatic hydrocarbons such as benzene (28.9), toluene (28.5), m-xylene (28.7), and p-xylene (28.3); halogenated hydrocarbons such as dichloromethane (27.9), chloroform (27.2), carbon tetrachloride (26.9), 1-chloropropane (21.8), and 2-chloropropane (18.1); ethers such as ethyl ether (17.1), propyl ether (20.5), isopropyl ether (17.7), butyl ethyl ether (20.8), and 1,2-dimethoxyethane (24.6); ketones such as acetone (23.3), methyl ethyl ketone (24.6), methyl propyl ketone (25.1), and diethyl ketone (25.3); and esters such as methyl acetate (24.8), ethyl acetate (23.8), propyl acetate (24.3), isopropyl acetate (21.2), isobutyl acetate (23.7), and ethyl butyrate (24.6) (the surface tension at 20° C. is indicated within the parentheses, and the unit is [mN/m]). Among these, an aliphatic hydrocarbon is acceptable, and hexane or heptane is acceptable, from the viewpoint of achieving low surface tension and excellent working environmental performance. Also, among these, a hydrophilic organic solvent such as acetone, methyl ethyl ketone, or 1,2-dimethoxyethane is used and thereby, can also serve as the organic solvent in the washing step. Among these, a solvent whose boiling point at normal pressure is 100° C. or lower may be used from the viewpoint that drying in the drying step is easy. The solvent having low surface tension may be used alone or by mixing two or more types.

An amount that can sufficiently replace the solvent in the thermal insulating layer after the washing may be used as the amount of the solvent used in the solvent replacement step, and the solvent in an amount of 3 to 10 times the volume of the thermal insulating layer can be used.

A temperature equal to or lower than the boiling point of the solvent used in replacement can be used as the temperature environment in the solvent replacement step. In the case of using, for example, heptane, a temperature on the order of 30 to 60° C. can be used.

In the present embodiment, in the case where the sol contains silica particles, the solvent replacement step is not always essential, as described above. A presumed mechanism is as follows. In the present embodiment, the silica particles function as a support of a three-dimensional network aerogel skeleton, whereby the skeleton is supported so that the shrinkage of the gel in the drying step is suppressed. Therefore, it is considered that the gel can be directly transferred to the drying step without replacing the solvent used in washing. As mentioned above, in the present embodiment, the simplification of the washing and solvent replacement step through the drying step is possible.

Depending on the upper temperature limit of the main body part, it is possible to volatilize or remove impurities by the drying step after the aging step without performing the washing and solvent replacement step.

{Drying Step}

In the drying step, the thermally insulated body washed and (if necessary) solvent-replaced as described above is dried. By this, a final thermally insulated body can be obtained.

The drying approach is not particularly limited, and publicly known drying under normal pressure, supercritical drying or freeze drying can be used. Among these, drying under normal pressure or supercritical drying can be used from the viewpoint of easily manufacturing a thermal insulating layer having a low density. Drying under normal pressure can be used from the viewpoint that production at a low cost is possible. In the present embodiment, the “normal pressure” means 0.1 MPa (atmospheric pressure).

The thermally insulated body according to the present embodiment can be obtained, for example, by drying the washed and (if necessary) solvent-replaced thermally insulated body under atmospheric pressure at a temperature lower than the critical point of the solvent used in drying. The drying temperature may be 60 to 500° C. and may be 90 to 150° C., though differing depending on the type of the replaced solvent (solvent used in washing in the case of not performing solvent replacement), or the heat resistance of the thermal insulating layer. The drying time may be 2 to 48 hours, though differing depending on the volume of the thermal insulating layer and the drying temperature. In the present embodiment, the drying can also be accelerated by applying pressure within a range not inhibiting productivity.

The thermally insulated body according to the present embodiment may be subjected to predrying before the drying step from the viewpoint of suppressing cracks in the aerogel ascribable to rapid drying. The predrying temperature may be 60 to 180° C. and may be 90 to 150° C. The predrying time may be 1 to 30 minutes, though differing depending on the volume of the thermal insulating layer and the drying temperature.

The method for manufacturing a thermally insulated body and the thermally insulated body according to the present embodiment can be applied to thermal insulation purposes in, for example, cryogenic vessels, the space field, the architecture field, the automobile field, the field of household appliances, the semiconductor field and industrial facilities. More specifically, the method for manufacturing a thermally insulated body and the thermally insulated body according to the present embodiment can be applied to thermal insulation purposes in, for example, engines (e.g., automobile engines), turbines, and electric furnaces. Also, the thermal insulating layer according to the present embodiment can be utilized for water-repellent purposes, sound absorption purposes, seiche purposes, catalyst-supporting purposes and the like, in addition to purposes as thermal insulating materials.

### EXAMPLES

Although the present invention will be further specifically described below with reference to Examples, the present invention is not limited by these Examples.

### Examples I-1 to I-7 and Comparative Example I-1 and Comparative Example 1-2

### Preparation of Thermally Insulated Body (Hereinafter, Also Referred to as an “Aerogel Composite Structure”

### Example I-1

### [Sol Coating Liquid I-1]

100.0 parts by mass of PL-2L (product name, manufactured by Fuso Chemical Co., Ltd., average primary particle diameter: 20 nm, solid content: 20% by mass) as a silica particle-containing raw material, 120.0 parts by mass of water, 80.0 parts by mass of methanol, and 0.10 parts by mass of acetic acid as an acid catalyst were mixed to obtain a mixture. 60.0 parts by mass of methyltrimethoxysilane (manufactured by Shin-Etsu Chemical Co., Ltd., product name: LS-530; in some cases, abbreviated to “MTMS”) and 40.0 parts by mass of dimethyldimethoxysilane (manufactured by Shin-Etsu Chemical Co., Ltd., product name: LS-520; in some cases, abbreviated to “DMDMS”) were added as silicon compounds to this mixture, and reacted at 25° C. for 2 hours. 40.0 parts by mass of 5% concentration of ammonia water were added thereto as a base catalyst to obtain sol coating liquid I-1.

[Aerogel Composite Structure I-1]

The sol coating liquid I-1 was applied to a (length) 300 mm×(width) 300 mm×(thickness) 0.5 mm aluminum alloy plate (main body part, A6061P, alumite-treated, manufactured by Takeuchi Metal & Foil Co., Ltd.) by using an air brush (manufactured by ANEST IWATA Corporation, product name: HP-CP) such that the thickness after gelling became 100 μm, and gelled at 60° C. for 30 minutes to obtain a structure. Then, the obtained structure was transferred to a closed vessel and aged at 60° C. for 12 hours.

Then, the aged structure was dipped in 2000 mL of water and washed over 30 minutes. Next, the resultant was dipped in 2000 mL of methanol and washed at 60° C. over 30 minutes. Washing with methanol was further performed twice while the methanol was replaced with a fresh one. Next, the resultant was dipped in 2000 mL of methyl ethyl ketone, and solvent replacement was performed at 60° C. over 30 minutes. Washing with methyl ethyl ketone was further performed twice while the methyl ethyl ketone was replaced with a fresh one. The washed and solvent-replaced structure was dried under normal pressure at 120° C. for 6 hours to obtain aerogel composite structure I-1 having aerogel layer I-1 (aerogel layer integrally joined with the main body part, thickness: 100 μm).

### Example I-2

### [Sol Coating Liquid I-2]

100.0 parts by mass of ST-OZL-35 (product name, manufactured by Nissan Chemical Industries, Ltd., average primary particle diameter: 100 nm, solid content: 35% by mass) as a silica particle-containing raw material, 100.0 parts by mass of water, 0.10 parts by mass of acetic acid as an acid catalyst, 20.0 parts by mass of CTAB as a cationic surfactant, and 120.0 parts by mass of urea as a thermally hydrolyzable compound were mixed to obtain a mixture. 60.0 parts by mass of MTMS as a silicon compound and 20.0 parts by mass of X-22-160AS (product name, manufactured by Shin-Etsu Chemical Co., Ltd.) as a polysiloxane compound having a structure represented by the above formula (A) were added to this mixture, and reacted at 25° C. for 2 hours. Then, sol-gel reaction was performed at 60° C. for 5 hours to obtain sol coating liquid I-2.

[Aerogel Composite Structure I-2]

The sol coating liquid I-2 was applied to a (length) 300 mm×(width) 300 mm×(thickness) 0.5 mm aluminum plate (main body part, A1035P) by using a bar coater such that the thickness after gelling became 100 μm, and gelled at 60° C. for 30 minutes to obtain a structure. Then, the obtained structure was transferred to a closed vessel and aged at 60° C. for 12 hours.

Then, the washing and solvent replacement step and the drying step were performed in the same way as in Example I-1 to obtain aerogel composite structure I-2 having aerogel layer I-2 (aerogel layer integrally joined with the main body part, thickness: 100 μm) containing aerogel having structures represented by the above formulas (1), (1a) and (4).

### Example I-3

### [Sol Coating Liquid I-3]

100.0 parts by mass of PL-2L as a silica particle-containing raw material, 100.0 parts by mass of water, 0.10 parts by mass of acetic acid as an acid catalyst, 20.0 parts by mass of CTAB as a cationic surfactant, and 120.0 parts by mass of urea as a thermally hydrolyzable compound were mixed to obtain a mixture. 80.0 parts by mass of MTMS as a silicon compound and 20.0 parts by mass of a both terminally difunctional alkoxy-modified polysiloxane compound having a structure represented by the above formula (B) (hereinafter, referred to as “polysiloxane compound I-A”) as a polysiloxane compound were added to this mixture, and reacted at 25° C. for 2 hours. Then, sol-gel reaction was performed at 60° C. for 2 hours to obtain sol coating liquid I-3.

The “polysiloxane compound I-A” was synthesized as follows: first, in a 1 L three-neck flask equipped with a stirrer, a thermometer and a Dimroth condenser, 100.0 parts by mass of dimethylpolysiloxane XC96-723 having silanol groups at both ends (product name, manufactured by Momentive Performance Materials Inc.), 181.3 parts by mass of methyltrimethoxysilane, and 0.50 parts by mass of t-butylamine were mixed and reacted at 30° C. for 5 hours. Then, volatile matter was removed by heating this reaction solution under reduced pressure of 1.3 kPa at 140° C. for 2 hours, to obtain the both terminally difunctional alkoxy-modified polysiloxane compound (polysiloxane compound I-A).

[Aerogel Composite Structure I-3]

The sol coating liquid I-3 was placed in a tray, and a (length) 254 mm×(width) 254 mm×(thickness) 6.3 mm polyimide plate (main body part, manufactured by DuPont K.K., product name: Vespel® SP-1) was dipped in the sol coating liquid I-3 and then taken out, followed by gelling at 60° C. for 30 minutes to obtain a structure having a gel layer thickness of 100 μm. Then, the obtained structure was transferred to a closed vessel and aged at 60° C. for 12 hours.

Then, the washing and solvent replacement step and the drying step were performed in the same way as in Example I-1 to obtain aerogel composite structure I-3 having aerogel layer I-3 (aerogel layer integrally joined with the main body part, thickness: 100 μm) containing aerogel having structures represented by the above formulas (2), (3), (4) and (5).

### Example I-4

### [Sol Coating Liquid I-4]

100.0 parts by mass of PL-2L as a silica particle-containing raw material, 200.0 parts by mass of water, 0.10 parts by mass of acetic acid as an acid catalyst, 20.0 parts by mass of CTAB as a cationic surfactant, and 120.0 parts by mass of urea as a thermally hydrolyzable compound were mixed to obtain a mixture. 60.0 parts by mass of MTMS as a silicon compound and 40.0 parts by mass of a both terminally trifunctional alkoxy-modified polysiloxane compound having a structure represented by the above formula (B) (hereinafter, referred to as “polysiloxane compound I-B”) as a polysiloxane compound were added to this mixture, and reacted at 25° C. for 2 hours. Then, sol-gel reaction was performed at 60° C. for 2 hours to obtain sol coating liquid I-4.

The “polysiloxane compound I-B” was synthesized as follows: first, in a 1L three-neck flask equipped with a stirrer, a thermometer and a Dimroth condenser, 100.0 parts by mass of XC96-723, 202.6 parts by mass of tetramethoxysilane, and 0.50 parts by mass of t-butylamine were mixed and reacted at 30° C. for 5 hours. Then, volatile matter was removed by heating this reaction solution under reduced pressure of 1.3 kPa at 140° C. for 2 hours, to obtain the both terminally trifunctional alkoxy-modified polysiloxane compound (polysiloxane compound I-B).

[Aerogel Composite Structure I-4]

Aerogel composite structure I-4 having aerogel layer I-4 (aerogel layer integrally joined with the main body part, thickness: 100 μm) containing aerogel having structures represented by the above formulas (2) and (4) was obtained in the same way as in Example I-1 except that the sol coating liquid I-4 was used instead of the sol coating liquid I-1, and a (length) 26 mm×(width) 76 mm×(thickness) 1.3 mm glass slide (main body part, manufactured by Matsunami Glass Ind., Ltd., product number: S-1214) was used.

### Example I-5

### [Sol Coating Liquid I-5]

100.0 parts by mass of PL-2L as a silica particle-containing raw material, 100.0 parts by mass of water, 0.10 parts by mass of acetic acid as an acid catalyst, 20.0 parts by mass of CTAB as a cationic surfactant, and 120.0 parts by mass of urea as a thermally hydrolyzable compound were mixed to obtain a mixture. 60.0 parts by mass of MTMS and 40.0 parts by mass of DMDMS were added as silicon compounds to this mixture, and reacted at 25° C. for 2 hours. Then, sol-gel reaction was performed at 60° C. for 1.0 hour to obtain sol coating liquid I-5.

[Aerogel Composite Structure I-5]

Aerogel composite structure I-5 having aerogel layer I-5 (aerogel layer integrally joined with the main body part, thickness: 100 μm) containing aerogel having structures represented by the above formulas (4) and (5) was obtained in the same way as in Example I-1 except that the sol coating liquid I-5 was used instead of the sol coating liquid I-1, and a (length) 300 mm×(width) 300 mm×(thickness) 0.5 mm alumina plate (manufactured by Asuzac Inc., product number: AR-99.6) was used.

### Example I-6

### [Sol Coating Liquid I-6]

100.0 parts by mass of PL-2L as a silica particle-containing raw material, 100.0 parts by mass of water, 0.10 parts by mass of acetic acid as an acid catalyst, 20.0 parts by mass of CTAB as a cationic surfactant, and 120.0 parts by mass of urea as a thermally hydrolyzable compound were mixed to obtain a mixture. 60.0 parts by mass of MTMS and 20.0 parts by mass of DMDMS as silicon compounds, and 20.0 parts by mass of X-22-160AS as a polysiloxane compound were added to this mixture, and reacted at 25° C. for 2 hours. Then, sol-gel reaction was performed at 60° C. for 1.0 hour to obtain sol coating liquid I-6.

[Aerogel Composite Structure I-6]

Aerogel composite structure I-6 having aerogel layer I-6 (aerogel layer integrally joined with the main body part, thickness: 100 μm) containing aerogel having structures represented by the above formulas (1), (1a), (4) and (5) was obtained in the same way as in Example I-1 except that the sol coating liquid I-6 was used instead of the sol coating liquid I-1, and a (length) 300 mm×(width) 200 mm×(thickness) 3 mm nonwoven glass fabric (main body part, manufactured by Nippon Sheet Glass Co., Ltd., product name: MGP® BMS-5) was used.

### Example I-7

[Sol Coating Liquid I-7]

100.0 parts by mass of PL-2L as a silica particle-containing raw material, 100.0 parts by mass of water, 0.10 parts by mass of acetic acid as an acid catalyst, 20.0 parts by mass of CTAB as a cationic surfactant, and 120.0 parts by mass of urea as a thermally hydrolyzable compound were mixed to obtain a mixture. 60.0 parts by mass of MTMS and 20.0 parts by mass of DMDMS as silicon compounds, and 20.0 parts by mass of the polysiloxane compound I-A as a polysiloxane compound were added to this mixture, and reacted at 25° C. for 2 hours. Then, sol-gel reaction was performed at 60° C. for 1.0 hour to obtain sol coating liquid I-7.

[Aerogel Composite Structure I-7]

Aerogel composite structure I-7 having aerogel layer I-7 (aerogel layer integrally joined with the main body part, thickness: 100 μm) containing aerogel having structures represented by the above formulas (2), (3), (4) and (5) was obtained in the same way as in Example I-1 except that the sol coating liquid I-7 was used instead of the sol coating liquid I-1, and a (length) 300 mm×(width) 200 mm×(thickness) 3 mm nonwoven ceramic fabric (main body part, manufactured by Oribest Co., Ltd., product name: CERABESTOS®) was used.

### Comparative Example I-1

Urethane foam (manufactured by Henkel Japan Ltd., product name: Sista M5230) was applied to the aluminum alloy plate used as a main body part in Example I-1 such that the thickness became 100 μm, to obtain a urethane foam structure.

### Comparative Example 1-2

Expanded polystyrene (manufactured by Kuriyama Kasei Kogyosho K.K., expansion ratio: 60) was bonded with Concrete Bond (product name, manufactured by Konishi Co., Ltd.) to the aluminum alloy plate used as a main body part in Example 1-1 such that the thickness became 100 μm, to obtain an expanded polystyrene structure.

<Various Evaluations>

### (Thermal Insulation Property Evaluation)

The aerogel composite structure obtained in each Example or the structure obtained in each Comparative Example (urethane foam structure and expanded polystyrene structure) was placed on a hot plate with a surface temperature of 70° C. such that the aerogel layer, the urethane foam layer or the expanded polystyrene layer became an undersurface, and heated, and 10 minutes later, the surface temperature of the structure was measured by thermography (manufactured by Apiste Corporation, Infrared Thermoviewer FSV-1200-L16). The sample temperature before the heating and room temperature were 23° C.

(Flame Retardance Evaluation)

Flame retardance evaluation was conducted by contacting flame with the aerogel layer, the urethane foam layer or the expanded polystyrene layer of the aerogel composite structure obtained in each Example or the structure obtained in each Comparative Example in accordance with JIS A 1322 (Testing Method for Incombustibility of Thin Materials for Buildings).

(Heat Resistance Evaluation)

The aerogel composite structure obtained in each Example or the structure obtained in each Comparative Example was placed on a hot plate with a surface temperature of 200° C. such that the aerogel layer, the urethane foam layer or the expanded polystyrene layer became an undersurface, and heated at 200° C. for 5 minutes. After the heating, visual observation was performed to evaluate appearance such as deformation, discoloration, or peeling. In the case where there was no change in the visual observation, good heat resistance was determined, and in the case where deformation, discoloration, peeling, or the like occurred, poor heat resistance was determined.

TABLE 1

| | | | Thermal insulation | | |
|---|---|---|---|---|---|
| | | | property (surface | Flame | Heat |
| Item | Constitution | | temperature) | retardance | resistance |
| Example I-1 | Aerogel layer | Aluminum alloy | 35° C. | Anti-flame | Good |
| | I-1 | plate | | grade 1 | |
| Example I-2 | Aerogel layer | Aluminum plate | 35° C. | Anti-flame | Good |
| | I-2 | | | grade 1 | |
| Example I-3 | Aerogel layer | Polyimide plate | 30° C. | Anti-flame | Good |
| | I-3 | | | grade 1 | |
| Example I-4 | Aerogel layer | Glass slide | 32° C. | Anti-flame | Good |
| | I-4 | | | grade 1 | |
| Example I-5 | Aerogel layer | Alumina plate | 33° C. | Anti-flame | Good |
| | I-5 | | | grade 1 | |
| Example I-6 | Aerogel layer | Nonwoven glass | 27° C. | Anti-flame | Good |
| | I-6 | fabric | | grade 1 | |
| Example I-7 | Aerogel layer | Nonwoven ceramic | 27° C. | Anti-flame | Good |
| | I-7 | fabric | | grade 1 | |
| Comparative | Urethane foam | Aluminum alloy | 45° C. | Combustion | Poor (brown |
| Example I-1 | layer | plate | | | discoloration) |
| Comparative | Expanded | Aluminum alloy | 60° C. | Combustion | Poor (melting) |
| Example I-2 | polystyrene | plate | | | |
| | layer | | | | |

From Table 1, in Examples, the thermal insulation properties, the flame retardance and the heat resistance are good. Therefore, reduction in thickness as compared with conventional materials is possible even in the case of use in a high-temperature environment, and flame retardance can be conferred. On the other hand, in Comparative Examples, all of the properties, thermal insulation properties (low thermal conductivity), flame retardance and heat resistance, are poor, and effects equivalent to Examples cannot be obtained.

### Examples II-1 to II-12 and Comparative Example II-1 and Comparative Example II-2

### (Main Body Part)

The following aluminum alloy plate, aluminum plate, polyimide plate, glass slide, alumina plate, nonwoven glass fabric and nonwoven ceramic fabric were provided as a main body part.

Aluminum alloy plate: A6061P (product name, manufactured by Takeuchi Metal & Foil Co., Ltd., size: 300 mm×300 mm×0.5 mm, alumite-treated)
Aluminum plate: A1035P (product name, manufactured by Takeuchi Metal & Foil Co., Ltd., size: 300 mm×300 mm×0.5 mm)
Polyimide plate: Vespel® SP-1 (product name, manufactured by DuPont K.K., size: 254 mm×254 mm×6.3 mm)
Glass slide: S-1214 (product number, manufactured by Matsunami Glass Ind., Ltd., size: 26 mm×76 mm×1.3 mm)
Alumina plate: AR-99.6 (product number, manufactured by Asuzac Inc., size: 300 mm×300 mm×0.5 mm)
Nonwoven glass fabric: MGP® BMS-5 (product name, manufactured by Nippon Sheet Glass Co., Ltd., size: 300 mm×200 mm×3 mm)
Nonwoven ceramic fabric: CERABESTOS® (product name, manufactured by Oribest Co., Ltd., size: 300 mm×200 mm×3 mm)

### Examples II-1 to II-12

### (Formation of Covering Layer (Hereinafter, Also Referred to as an “Intermediate Layer”))

Intermediate layers II-1 to II-5 were formed on the various provided main body parts as described below according to the combinations shown in Table 2. Aside from this, test specimens corresponding to the intermediate layers II-1 to II-5 were prepared, and the percentages of water absorption of the intermediate layers II-1 to II-5 were measured. Specifically, the rate of change in mass in leaving the test specimen of each intermediate layer molded into a size of 20 mm×20 mm×0.5 mm for 6 hours in a thermo-hygrostat of 60° C. and 90% RH was regarded as the percentage of water absorption. The measurement results are shown in Table 3.

[Intermediate Layer II-1]

The main body part was coated by using an air brush (manufactured by ANEST IWATA Corporation, product name: HP-CP) with Silicon HR Primer (product name, manufactured by Chugoku Marine Paints, Ltd.) as a silicone-based primer liquid, which was then cured by heating at 40° C. for 1 hour and further at 200° C. for 2 hours to form a layer having a thickness of 30 μm (intermediate layer II-1) on the main body part.

[Intermediate Layer II-2]

The main body part was coated by using a bar coater with a mixture of Aron Ceramic E (product name, manufactured by Toa Gosei Co., Ltd.) and fused silica (manufactured by Admatechs Co., Ltd., SO-25R) as an inorganic primer liquid, which was then cured by heating at 90° C. for 1 hour and further at 150° C. for 2 hours to form a layer having a thickness of 100 μm (intermediate layer II-2) on the main body part. The content of the fused silica (filler) contained in the obtained intermediate layer II-2 was 0.5% by volume with respect to the total volume of the intermediate layer.

[Intermediate Layer II-3]

The main body part was coated by using a bar coater with a sodium silicate solution (approximately 38% by mass) (manufactured by Wako Pure Chemical Industries, Ltd., reagent) as an inorganic primer liquid, which was then cured by heating at 300° C. for 2 hours to form a layer having a thickness of 50 μm (intermediate layer II-3) on the main body part.

[Intermediate Layer II-4]

The main body part was coated by using a bar coater with a mixture of TB3732 (product name, manufactured by ThreeBond Holdings Co., Ltd.) and magnesium hydroxide (manufactured by Wako Pure Chemical Industries, Ltd., reagent) as an inorganic primer liquid, which was then cured by heating at 50° C. for 30 minutes and further at 100° C. for 1 hour to form a layer having a thickness of 10 μm (intermediate layer II-4) on the main body part. The content of the magnesium hydroxide (filler) contained in the obtained intermediate layer II-4 was 20% by volume with respect to the total volume of the intermediate layer.

[Intermediate Layer II-5]

API-114A (product name, manufactured by Chukoh Chemical Industries, Ltd.) as a polyimide-based pressure-sensitive adhesive tape was attached to the main body part to form a layer having a thickness of 60 μm (intermediate layer II-5) on the main body part.

(Sol Coating Liquid)

### [Sol Coating Liquid II-1]

100.0 parts by mass of PL-2L (product name, manufactured by Fuso Chemical Co., Ltd., average primary particle diameter: 20 nm, solid content: 20% by mass) as a silica particle-containing raw material, 120.0 parts by mass of water, 80.0 parts by mass of methanol and 0.10 parts by mass of acetic acid as an acid catalyst were mixed to obtain a mixture. 60.0 parts by mass of methyltrimethoxysilane (manufactured by Shin-Etsu Chemical Co., Ltd., product name: LS-530; also referred to as “MTMS”) and 40.0 parts by mass of dimethyldimethoxysilane (manufactured by Shin-Etsu Chemical Co., Ltd., product name: LS-520; also referred to as “DMDMS”) were added as silicon compounds to this mixture, and reacted at 25° C. for 2 hours. 40.0 parts by mass of 5% concentration of ammonia water were added thereto as a base catalyst to obtain sol coating liquid II-1.

[Sol Coating Liquid II-2]

100.0 parts by mass of ST-OZL-35 (manufactured by Nissan Chemical Industries, Ltd., product name, average primary particle diameter: 100 nm, solid content: 35% by mass) as a silica particle-containing raw material, 100.0 parts by mass of water, 0.10 parts by mass of acetic acid as an acid catalyst, 20.0 parts by mass of CTAB as a cationic surfactant and 120.0 parts by mass of urea as a thermally hydrolyzable compound were mixed to obtain a mixture. 60.0 parts by mass of MTMS as a silicon compound and 20.0 parts by mass of X-22-160AS (product name, manufactured by Shin-Etsu Chemical Co., Ltd.) as a polysiloxane compound having a structure represented by the above formula (A) were added to this mixture, and reacted at 25° C. for 2 hours. Then, sol-gel reaction was performed at 60° C. for 5 hours to obtain sol coating liquid II-2.

[Sol Coating Liquid II-3]

100.0 parts by mass of PL-2L as a silica particle-containing raw material, 100.0 parts by mass of water, 0.10 parts by mass of acetic acid as an acid catalyst, 20.0 parts by mass of CTAB as a cationic surfactant and 120.0 parts by mass of urea as a thermally hydrolyzable compound were mixed to obtain a mixture. 80.0 parts by mass of MTMS as a silicon compound and 20.0 parts by mass of a both terminally difunctional alkoxy-modified polysiloxane compound having a structure represented by the above formula (B) (hereinafter, referred to as “polysiloxane compound II-A”) as a polysiloxane compound were added to this mixture, and reacted at 25° C. for 2 hours. Then, sol-gel reaction was performed at 60° C. for 2 hours to obtain sol coating liquid II-3.

The “polysiloxane compound II-A” was synthesized as follows: first, in a 1 L three-neck flask equipped with a stirrer, a thermometer and a Dimroth condenser, 100.0 parts by mass of dimethylpolysiloxane having silanol groups at both ends (manufactured by Momentive Performance Materials Inc., product name: XC96-723), 181.3 parts by mass of methyltrimethoxysilane and 0.50 parts by mass of t-butylamine were mixed and reacted at 30° C. for 5 hours. Then, volatile matter was removed by heating this reaction solution under reduced pressure of 1.3 kPa at 140° C. for 2 hours, to obtain the both terminally difunctional alkoxy-modified polysiloxane compound (polysiloxane compound II-A).

[Sol Coating Liquid II-4]

100.0 parts by mass of PL-2L as a silica particle-containing raw material, 200.0 parts by mass of water, 0.10 parts by mass of acetic acid as an acid catalyst, 20.0 parts by mass of CTAB as a cationic surfactant and 120.0 parts by mass of urea as a thermally hydrolyzable compound were mixed to obtain a mixture. 60.0 parts by mass of MTMS as a silicon compound and 40.0 parts by mass of a both terminally trifunctional alkoxy-modified polysiloxane compound having a structure represented by the above formula (B) (hereinafter, referred to as “polysiloxane compound II-B”) as a polysiloxane compound were added to this mixture, and reacted at 25° C. for 2 hours. Then, sol-gel reaction was performed at 60° C. for 2 hours to obtain sol coating liquid II-4.

The “polysiloxane compound II-B” was synthesized as follows: first, in a 1 L three-neck flask equipped with a stirrer, a thermometer and a Dimroth condenser, 100.0 parts by mass of XC96-723, 202.6 parts by mass of tetramethoxysilane and 0.50 parts by mass of t-butylamine were mixed and reacted at 30° C. for 5 hours. Then, volatile matter was removed by heating this reaction solution under reduced pressure of 1.3 kPa at 140° C. for 2 hours, to obtain the both terminally trifunctional alkoxy-modified polysiloxane compound (polysiloxane compound II-B).

[Sol Coating Liquid II-5]

100.0 parts by mass of PL-2L as a silica particle-containing raw material, 100.0 parts by mass of water, 0.10 parts by mass of acetic acid as an acid catalyst, 20.0 parts by mass of CTAB as a cationic surfactant and 120.0 parts by mass of urea as a thermally hydrolyzable compound were mixed to obtain a mixture. 60.0 parts by mass of MTMS and 40.0 parts by mass of DMDMS were added as silicon compounds to this mixture, and reacted at 25° C. for 2 hours. Then, sol-gel reaction was performed at 60° C. for 1.0 hour to obtain sol coating liquid II-5.

[Sol Coating Liquid II-6]

100.0 parts by mass of PL-2L as a silica particle-containing raw material, 100.0 parts by mass of water, 0.10 parts by mass of acetic acid as an acid catalyst, 20.0 parts by mass of CTAB as a cationic surfactant and 120.0 parts by mass of urea as a thermally hydrolyzable compound were mixed to obtain a mixture. 60.0 parts by mass of MTMS and 20.0 parts by mass of DMDMS as silicon compounds, and 20.0 parts by mass of X-22-160AS as a polysiloxane compound were added to this mixture, and reacted at 25° C. for 2 hours. Then, sol-gel reaction was performed at 60° C. for 1.0 hour to obtain sol coating liquid II-6.

[Sol Coating Liquid II-7]

100.0 parts by mass of PL-2L as a silica particle-containing raw material, 100.0 parts by mass of water, 0.10 parts by mass of acetic acid as an acid catalyst, 20.0 parts by mass of CTAB as a cationic surfactant and 120.0 parts by mass of urea as a thermally hydrolyzable compound were mixed to obtain a mixture. 60.0 parts by mass of MTMS and 20.0 parts by mass of DMDMS as silicon compounds, and 20.0 parts by mass of the polysiloxane compound II-A as a polysiloxane compound were added to this mixture, and reacted at 25° C. for 2 hours. Then, sol-gel reaction was performed at 60° C. for 1.0 hour to obtain sol coating liquid II-7.

(Preparation of Thermally Insulated Body (Aerogel Composite Structure))

Aerogel layers II-1 to II-7 were formed on the intermediate layers as described below according to the combinations shown in Table 2 to prepare aerogel composite structures having a main body part and an aerogel layer integrally joined with the main body part via an intermediate layer.

[Aerogel layer II-1]

The sol coating liquid II-1 was applied onto the intermediate layer by using an air brush (manufactured by ANEST IWATA Corporation, product name: HP-CP) such that the thickness after gelling became 100 μm, and gelled at 60° C. for 30 minutes to obtain a structure. Then, the obtained structure was transferred to a closed vessel and aged at 60° C. for 12 hours.

Then, the aged structure was dipped in 2000 mL of water and washed over 30 minutes. Next, the resultant was dipped in 2000 mL of methanol and washed at 60° C. over 30 minutes. Washing with methanol was further performed twice while the methanol was replaced with a fresh one. Next, the resultant was dipped in 2000 mL of methyl ethyl ketone, and solvent replacement was performed at 60° C. over 30 minutes. Washing with methyl ethyl ketone was further performed twice while the methyl ethyl ketone was replaced with a fresh one. The washed and solvent-replaced structure was dried under normal pressure at 120° C. for 6 hours to obtain an aerogel composite structure having aerogel layer II-1 (aerogel layer integrally joined with the main body part via the intermediate layer).

[Aerogel Layer II-2]

The sol coating liquid II-2 was applied onto the intermediate layer by using a bar coater such that the thickness after gelling became 200 μm, and gelled at 60° C. for 30 minutes to obtain a structure. Then, the obtained structure was transferred to a closed vessel and aged at 60° C. for 12 hours.

Then, the washing and solvent replacement step and the drying step were performed in the same way as the method described in “Aerogel layer II-1” to obtain an aerogel composite structure having aerogel layer II-2 (aerogel layer integrally joined with the main body part via the intermediate layer) containing aerogel having structures represented by the above formulas (1), (1a) and (4).

[Aerogel Layer II-3]

The sol coating liquid II-3 was placed in a tray, and the main body part with the intermediate layer formed was dipped in the sol coating liquid II-3 and then taken out, followed by gelling at 60° C. for 30 minutes to obtain a structure having a gel layer thickness of 100 μm. Then, the obtained structure was transferred to a closed vessel and aged at 60° C. for 12 hours.

Then, the washing and solvent replacement step and the drying step were performed in the same way as the method described in “Aerogel layer II-1” to obtain an aerogel composite structure having aerogel layer II-3 (aerogel layer integrally joined with the main body part via the intermediate layer) containing aerogel having structures represented by the above formulas (2), (3), (4) and (5).

[Aerogel Layer II-4]

An aerogel composite structure having aerogel layer II-4 (aerogel layer integrally joined with the main body part via the intermediate layer) containing aerogel having structures represented by the above formulas (2) and (4) was obtained in the same way as the method described in “Aerogel layer II-1” except that the sol coating liquid II-4 was used instead of the sol coating liquid II-1, and the thickness after gelling was set to 50 run.

[Aerogel Layer II-5]

An aerogel composite structure having aerogel layer II-5 (aerogel layer integrally joined with the main body part via the intermediate layer) containing aerogel having structures represented by the above formulas (4) and (5) was obtained in the same way as the method described in “Aerogel layer II-1” except that the sol coating liquid II-5 was used instead of the sol coating liquid II-1.

[Aerogel Layer II-6]

An aerogel composite structure having aerogel layer II-6 (aerogel layer integrally joined with the main body part via the intermediate layer) containing aerogel having structures represented by the above formulas (1), (1a), (4) and (5) was obtained in the same way as the method described in “Aerogel layer II-1” except that the sol coating liquid II-6 was used instead of the sol coating liquid II-1.

[Aerogel Layer II-7]

An aerogel composite structure having aerogel layer II-7 (aerogel layer integrally joined with the main body part via the intermediate layer) containing aerogel having structures represented by the above formulas (2), (3), (4) and (5) was obtained in the same way as the method described in “Aerogel layer II-1” except that the sol coating liquid II-7 was used instead of the sol coating liquid II-1.

TABLE 2

| | Constitution | | | Filler in | Percentage of water | |
|---|---|---|---|---|---|---|
| | Main body | | | intermediate | absorption of | Thickness of |
| Item | part | Intermediate layer | Aerogel layer | layer | intermediate layer | aerogel layer |
| Example II-1 | Aluminum | Intermediate layer II-1 | Aerogel layer | — | 0.8 | 100 |
| | alloy plate | (silicone-based) | II-1 | | | |
| Example II-2 | Aluminum | Intermediate layer II-2 | Aerogel layer | Fused silica | 1.0 | 200 |
| | alloy plate | (inorganic) | II-2 | | | |
| Example II-3 | Aluminum | Intermediate layer II-3 | Aerogel layer | — | 0.5 | 100 |
| | alloy plate | (inorganic) | II-1 | | | |
| Example II-4 | Aluminum | Intermediate layer II-1 | Aerogel layer | — | 0.8 | 100 |
| | plate | (silicone-based) | II-1 | | | |
| Example II-5 | Aluminum | Intermediate layer II-4 | Aerogel layer | Magnesium | 1.8 | 100 |
| | plate | (inorganic) | II-3 | hydroxide | | |
| Example II-6 | Polyimide | Intermediate layer II-1 | Aerogel layer | — | 0.8 | 50 |
| | plate | (silicone-based) | II-4 | | | |
| Example II-7 | Glass slide | Intermediate layer II-1 | Aerogel layer | — | 0.8 | 100 |
| | | (silicone-based) | II-5 | | | |
| Example II-8 | Glass slide | Intermediate layer II-5 | Aerogel layer | — | 2.5 | 100 |
| | | (polyimide-based) | II-6 | | | |
| Example II-9 | Alumina | Intermediate layer II-4 | Aerogel layer | Magnesium | 1.8 | 100 |
| | plate | (inorganic) | II-1 | hydroxide | | |
| Example II-10 | Nonwoven | Intermediate layer II-1 | Aerogel layer | — | 0.8 | 100 |
| | glass fabric | (silicone-based) | II-1 | | | |
| Example II-11 | Nonwoven | Intermediate layer II-4 | Aerogel layer | Magnesium | 1.8 | 50 |
| | glass fabric | (inorganic) | II-4 | hydroxide | | |
| Example II-12 | Nonwoven | Intermediate layer II-1 | Aerogel layer | — | 0.8 | 100 |
| | ceramic | (silicone-based) | II-7 | | | |
| | fabric | | | | | |

### Comparative Example II-1

Urethane foam (manufactured by Henkel Japan Ltd., product name: Sista M5230) was applied to the aluminum alloy plate as a main body part such that the thickness became 100 μm, to obtain a urethane foam structure.

### Comparative Example II-2

Crushed expanded polystyrene (manufactured by Kuriyama Kasei Kogyosho K.K., expansion ratio: 60) was bonded to the aluminum alloy plate as a main body part by using Concrete Bond (product name, manufactured by Konishi Co., Ltd.) such that the thickness became 100 μm, to obtain an expanded polystyrene structure.

<Various Evaluations>

### (Thermal Insulation Property Evaluation)

The aerogel composite structure obtained in each Example or the structure obtained in each Comparative Example (urethane foam structure and expanded polystyrene structure) was placed on a hot plate with a surface temperature of 70° C. such that the aerogel layer, the urethane foam layer or the expanded polystyrene layer became an undersurface, and heated, and 10 minutes later, the surface temperature of the structure was measured by thermography (manufactured by Apiste Corporation, Infrared Thermoviewer FSV-1200-L16). The measurement results are shown in Table 3. The sample temperature before the heating and room temperature are 23° C.

(Flame Retardance Evaluation)

Flame retardance evaluation was conducted by contacting flame with the aerogel layer, the urethane foam layer or the expanded polystyrene layer of the aerogel composite structure obtained in each Example or the structure obtained in each Comparative Example in accordance with JIS A 1322 (Testing Method for Incombustibility of Thin Materials for Buildings). The measurement results are shown in Table 3.

(Heat Resistance Evaluation)

The aerogel composite structure obtained in each Example or the structure obtained in each Comparative Example was placed on a hot plate with a surface temperature of 200° C. such that the aerogel layer, the urethane foam layer or the expanded polystyrene layer became an undersurface, and heated at 200° C. for 5 minutes. After the heating, visual observation was performed to evaluate appearance such as deformation, discoloration, or peeling. In the case where there was no change in the visual observation, good heat resistance was determined, and in the case where deformation, discoloration, peeling, or the like occurred, poor heat resistance was determined.

TABLE 3

| | | | | Thermal insulation | | |
|---|---|---|---|---|---|---|
| | | | | property (surface | Flame | Heat |
| Item | Constitution | | | temperature) | retardance | resistance |
| Example II-1 | Aluminum | Intermediate layer II-1 | Aerogel layer | 35° C. | Anti-flame | Good |
| | alloy plate | (silicon-based) | II-1 | | grade 1 | |
| Example II-2 | Aluminum | Intermediate layer II-2 | Aerogel layer | 35° C. | Anti-flame | Good |
| | alloy plate | (inorganic) | II-2 | | grade 1 | |
| Example II-3 | Aluminum | Intermediate layer II-3 | Aerogel layer | 35° C. | Anti-flame | Good |
| | alloy plate | (inorganic) | II-1 | | grade 1 | |
| Example II-4 | Aluminum | Intermediate layer II-1 | Aerogel layer | 35° C. | Anti-flame | Good |
| | plate | (silicon-based) | II-1 | | grade 1 | |
| Example II-5 | Aluminum | Intermediate layer II-4 | Aerogel layer | 35° C. | Anti-flame | Good |
| | plate | (inorganic) | II-3 | | grade 1 | |
| Example II-6 | Polyimide | Intermediate layer II-1 | Aerogel layer | 30° C. | Anti-flame | Good |
| | plate | (silicon-based) | II-4 | | grade 1 | |
| Example II-7 | Glass slide | Intermediate layer II-1 | Aerogel layer | 31° C. | Anti-flame | Good |
| | | (silicon-based) | II-5 | | grade 1 | |
| Example II-8 | Glass slide | Intermediate layer II-5 | Aerogel layer | 32° C. | Anti-flame | Good |
| | | (polyimide-based) | II-6 | | grade 1 | |
| Example II-9 | Alumina | Intermediate layer II-4 | Aerogel layer | 35° C. | Anti-flame | Good |
| | plate | (inorganic) | II-1 | | grade 1 | |
| Example II-10 | Nonwoven | Intermediate layer II-1 | Aerogel layer | 27° C. | Anti-flame | Good |
| | glass fabric | (silicon-based) | II-1 | | grade 1 | |
| Example II-11 | Nonwoven | Intermediate layer II-4 | Aerogel layer | 25° C. | Anti-flame | Good |
| | glass fabric | (inorganic) | II-4 | | grade 1 | |
| Example II-12 | Nonwoven | Intermediate layer II-1 | Aerogel layer | 27° C. | Anti-flame | Good |
| | ceramic | (silicon-based) | II-7 | | grade 1 | |
| | fabric | | | | | |
| Comparative | Aluminum | — | Urethane foam | 45° C. | Combustion | Poor (brown |
| Example II-1 | alloy plate | | layer | | | discoloration) |
| Comparative | Aluminum | Concrete Bond | Expanded | 60° C. | Combustion | Poor |
| Example II-2 | alloy plate | | polystyrene | | | (melting) |
| | | | layer | | | |

From Table 3, in Examples, the thermal insulation properties, the flame retardance and the heat resistance are good. Therefore, reduction in thickness as compared with conventional materials is possible even in the case of use in a high-temperature environment, and flame retardance can be conferred. On the other hand, in Comparative Examples, all of the properties, thermal insulation properties (low thermal conductivity), flame retardance and heat resistance, are poor, and effects equivalent to Examples cannot be obtained.

### Examples III-1 to III-8

### <Provision of Main Body Part>

Main Body Parts III-1 to III-8 were Provided.

Main body part III-1: (length) 100 mm×(width) 100 mm×(thickness) 2 mm aluminum plate (manufactured by Takeuchi Metal & Foil Co., Ltd., product name: A1050)
Main body part III-2: (length) 100 mm×(width) 100 mm×(thickness) 10 mm polyimide plate (manufactured by Ube Industries, Ltd., product name: Upimol® SA201)
Main body part III-3: (length) 100 mm×(width) 100 mm×(thickness) 2 mm aluminum alloy plate (manufactured by Takeuchi Metal & Foil Co., Ltd., product name: A6061P, alumite-treated)
Main body parts III-4 to III-6: (length) 100 mm×(width) 100 mm×(thickness) 2 mm alumina plate (manufactured by Asuzac Inc., product number: AR-99.6)
Main body part III-7: (length) 100 mm×(width) 100 mm×(thickness) 0.1 mm polyester film (manufactured by Toyobo Co., Ltd., product name: Cosmoshine® A4100)
Main body part III-8: (length) 100 mm×(width) 100 mm×(thickness) 0.012 mm polyaramide film (manufactured by Toray Industries, Inc., product name: Mictron®)

In this context, the main body parts III-4 to III-6 are materials differing in surface roughness (Ra).

<Measurement of Surface Roughness (Ra) of Main Body Part>

The arithmetic average roughness of the surface of each main body part was measured in accordance with JIS B0601 by using an optical surface roughness meter (manufactured by Veeco Metrology Group, Wyko NT9100). A measurement range in one measurement was set to 20 mm×20 mm. The measurement was performed as to 5 points on the surface of each main body part, and the average value was regarded as the surface roughness (Ra) of the main body part. The results are shown in Table 4.

TABLE 4

| | Surface roughness (Ra) |
|---|---|
| Main body part | μm |
| Main body part III-1 (aluminum plate) | 0.03 |
| Main body part III-2 (polyimide plate) | 0.16 |
| Main body part III-3 (aluminum alloy plate) | 0.29 |
| Main body part III-4 (alumina plate) | 1.1 |
| Main body part III-5 (alumina plate) | 3.5 |
| Main body part III-6 (alumina plate) | 12 |
| Main body part III-7 (polyester film) | 0.0003 |
| Main body part III-8 (polyaramide film) | 0.007 |

### Preparation of Thermally Insulated Body (Aerogel Composite Structure)

### Example III-1

### [Sol Coating Liquid III-1]

100.0 parts by mass of PL-2L (product name, manufactured by Fuso Chemical Co., Ltd., average primary particle diameter: 20 nm, solid content: 20% by mass) as a silica particle-containing raw material, 120.0 parts by mass of water, 80.0 parts by mass of methanol, and 0.10 parts by mass of acetic acid as an acid catalyst were mixed to obtain a mixture. 60.0 parts by mass of methyltrimethoxysilane (manufactured by Shin-Etsu Chemical Co., Ltd., product name: LS-530; also referred to as “MTMS”) and 40.0 parts by mass of dimethyldimethoxysilane (manufactured by Shin-Etsu Chemical Co., Ltd., product name: LS-520; also referred to as “DMDMS”) were added as silicon compounds to this mixture, and reacted at 25° C. for 2 hours. 40.0 parts by mass of 5% concentration of ammonia water were added thereto as a base catalyst to obtain sol coating liquid III-1.

[Aerogel Composite Structure III-1]

The sol coating liquid III-1 was applied to the main body part III-1 (aluminum plate) by using an air brush (manufactured by ANEST IWATA Corporation, product name: HP-CP) such that the thickness after gelling became 100 μm, and gelled at 60° C. for 30 minutes to obtain a structure. Then, the obtained structure was transferred to a closed vessel and aged at 60° C. for 12 hours.

Then, the aged structure was dipped in 2000 mL of water and washed over 30 minutes. Next, the resultant was dipped in 2000 mL of methanol and washed at 60° C. over 30 minutes. Washing with methanol was further performed twice while the methanol was replaced with a fresh one. Next, the resultant was dipped in 2000 mL of methyl ethyl ketone, and solvent replacement was performed at 60° C. over 30 minutes. Washing with methyl ethyl ketone was further performed twice while the methyl ethyl ketone was replaced with a fresh one. The washed and solvent-replaced structure was dried under normal pressure at 120° C. for 6 hours to obtain aerogel composite structure III-1 having aerogel layer III-1 (aerogel layer integrally joined with the main body part, thickness: 100 μm).

### Example III-2

### [Sol Coating Liquid III-2]

100.0 parts by mass of ST-OZL-35 (product name, manufactured by Nissan Chemical Industries, Ltd., average primary particle diameter: 100 nm, solid content: 35% by mass) as a silica particle-containing raw material, 100.0 parts by mass of water, 0.10 parts by mass of acetic acid as an acid catalyst, 20.0 parts by mass of CTAB as a cationic surfactant, and 120.0 parts by mass of urea as a thermally hydrolyzable compound were mixed to obtain a mixture. 60.0 parts by mass of MTMS as a silicon compound and 20.0 parts by mass of X-22-160AS (product name, manufactured by Shin-Etsu Chemical Co., Ltd.) as a polysiloxane compound having a structure represented by the above formula (A) were added to this mixture, and reacted at 25° C. for 2 hours. Then, sol-gel reaction was performed at 60° C. for 5 hours to obtain sol coating liquid III-2.

[Aerogel Composite Structure III-2]

The sol coating liquid III-2 was applied to the main body part III-2 (polyimide plate) by using a bar coater such that the thickness after gelling became 100 μm, and gelled at 60° C. for 30 minutes to obtain a structure. Then, the obtained structure was transferred to a closed vessel and aged at 60° C. for 12 hours.

Then, the washing and solvent replacement step and the drying step were performed in the same way as in Example III-1 to obtain aerogel composite structure III-2 having aerogel layer III-2 (aerogel layer integrally joined with the main body part, thickness: 100 μm) containing aerogel having structures represented by the above formulas (1), (1a) and (4).

### Example 11-3

### [Sol Coating Liquid III-3]

100.0 parts by mass of PL-2L as a silica particle-containing raw material, 100.0 parts by mass of water, 0.10 parts by mass of acetic acid as an acid catalyst, 20.0 parts by mass of CTAB as a cationic surfactant, and 120.0 parts by mass of urea as a thermally hydrolyzable compound were mixed to obtain a mixture. 80.0 parts by mass of MTMS as a silicon compound and 20.0 parts by mass of a both terminally difunctional alkoxy-modified polysiloxane compound having a structure represented by the above formula (B) (hereinafter, referred to as “polysiloxane compound III-A”) as a polysiloxane compound were added to this mixture, and reacted at 25° C. for 2 hours. Then, sol-gel reaction was performed at 60° C. for 2 hours to obtain sol coating liquid III-3.

The “polysiloxane compound III-A” was synthesized as follows: first, in a 1 L three-neck flask equipped with a stirrer, a thermometer and a Dimroth condenser, 100.0 parts by mass of dimethylpolysiloxane XC96-723 having silanol groups at both ends (product name, manufactured by Momentive Performance Materials Inc.), 181.3 parts by mass of methyltrimethoxysilane, and 0.50 parts by mass of t-butylamine were mixed and reacted at 30° C. for 5 hours. Then, volatile matter was removed by heating this reaction solution under reduced pressure of 1.3 kPa at 140° C. for 2 hours, to obtain the both terminally difunctional alkoxy-modified polysiloxane compound (polysiloxane compound III-A).

[Aerogel Composite Structure III-3]

The sol coating liquid III-3 was placed in a tray, and the main body part III-3 (aluminum alloy plate) was dipped in the sol coating liquid III-3 and then taken out, followed by gelling at 60° C. for 30 minutes to obtain a structure having a gel layer thickness of 100 μm. Then, the obtained structure was transferred to a closed vessel and aged at 60° C. for 12 hours.

Then, the washing and solvent replacement step and the drying step were performed in the same way as in Example III-1 to obtain aerogel composite structure III-3 having aerogel layer III-3 (aerogel layer integrally joined with the main body part, thickness: 100 μm) containing aerogel having structures represented by the above formulas (2), (3), (4) and (5).

### Example III-4

### [Sol Coating Liquid III-4]

100.0 parts by mass of PL-2L as a silica particle-containing raw material, 200.0 parts by mass of water, 0.10 parts by mass of acetic acid as an acid catalyst, 20.0 parts by mass of CTAB as a cationic surfactant, and 120.0 parts by mass of urea as a thermally hydrolyzable compound were mixed to obtain a mixture. 60.0 parts by mass of MTMS as a silicon compound and 40.0 parts by mass of a both terminally trifunctional alkoxy-modified polysiloxane compound having a structure represented by the above formula (B) (hereinafter, referred to as “polysiloxane compound III-B”) as a polysiloxane compound were added to this mixture, and reacted at 25° C. for 2 hours. Then, sol-gel reaction was performed at 60° C. for 2 hours to obtain sol coating liquid III-4.

The “polysiloxane compound III-B” was synthesized as follows: first, in a 1 L three-neck flask equipped with a stirrer, a thermometer and a Dimroth condenser, 100.0 parts by mass of XC96-723, 202.6 parts by mass of tetramethoxysilane, and 0.50 parts by mass of t-butylamine were mixed and reacted at 30° C. for 5 hours. Then, volatile matter was removed by heating this reaction solution under reduced pressure of 1.3 kPa at 140° C. for 2 hours, to obtain the both terminally trifunctional alkoxy-modified polysiloxane compound (polysiloxane compound III-B).

[Aerogel Composite Structure III-4]

Aerogel composite structure III-4 having aerogel layer III-4 (aerogel layer integrally joined with the main body part, thickness: 100 run) containing aerogel having structures represented by the above formulas (2) and (4) was obtained in the same way as in Example III-1 except that the sol coating liquid III-4 was used instead of the sol coating liquid III-1, and the main body part III-4 (alumina plate) was used instead of the main body part III-1.

### Example III-5

### [Sol Coating Liquid III-5]

100.0 parts by mass of PL-2L as a silica particle-containing raw material, 100.0 parts by mass of water, 0.10 parts by mass of acetic acid as an acid catalyst, 20.0 parts by mass of CTAB as a cationic surfactant, and 120.0 parts by mass of urea as a thermally hydrolyzable compound were mixed to obtain a mixture. 60.0 parts by mass of MTMS and 20.0 parts by mass of DMDMS as silicon compounds, and 20.0 parts by mass of X-22-160AS as a polysiloxane compound were added to this mixture, and reacted at 25° C. for 2 hours. Then, sol-gel reaction was performed at 60° C. for 1.0 hour to obtain sol coating liquid III-5.

[Aerogel Composite Structure III-5]

Aerogel composite structure III-5 having aerogel layer III-5 (aerogel layer integrally joined with the main body part, thickness: 100 μm) containing aerogel having structures represented by the above formulas (1), (1a), (4) and (5) was obtained in the same way as in Example III-1 except that the sol coating liquid III-5 was used instead of the sol coating liquid III-1, and the main body part III-5 (alumina plate) was used instead of the main body part III-1.

### Example III-6

Aerogel composite structure III-6 having aerogel layer III-1 (aerogel layer integrally joined with the main body part, thickness: 100 μm) was obtained in the same way as in Example III-1 except that the main body part III-6 (alumina plate) was used instead of the main body part III-1.

### Example III-7

Aerogel composite structure III-7 having aerogel layer III-1 (aerogel layer integrally joined with the main body part, thickness: 100 μm) was obtained in the same way as in Example III-1 except that the main body part III-7 (polyester film) was used instead of the main body part III-1.

### Example III-8

Aerogel composite structure III-8 having aerogel layer III-1 (aerogel layer integrally joined with the main body part, thickness: 100 μm) was obtained in the same way as in Example III-1 except that the main body part III-8 (polyaramide film) was used instead of the main body part III-1.

<Various Evaluations>

(Adhesion evaluation)

The adhesion between the main body part and the aerogel layer was evaluated by visually observing the presence or absence of peeling as to the aerogel composite structure obtained in each Example. In the case where the ratio of an area where the aerogel layer peeled so that the main body part was exposed was 0% or more and less than 5%, “A” was determined; in the case of being 5% or more and less than 10%, “B” was determined; and in the case of being 10% or more, “C” was determined.

(Thermal Insulation Property Evaluation)

The aerogel composite structure obtained in each Example was placed on a hot plate with a surface temperature of 70° C. such that the aerogel layer became an undersurface, and heated, and 10 minutes later, the surface temperature of the structure was measured by thermography (manufactured by Apiste Corporation, Infrared Thermoviewer FSV-1200-L16). The sample temperature before the heating and room temperature were 23° C.

(Flame Retardance Evaluation)

Flame retardance evaluation was conducted by contacting flame with the aerogel layer of the aerogel composite structure obtained in each Example in accordance with JIS A 1322 (Testing Method for Incombustibility of Thin Materials for Buildings).

(Heat Resistance Evaluation)

The aerogel composite structure obtained in each Example was placed on a hot plate with a surface temperature of 200° C. such that the aerogel layer became an undersurface, and heated at 200° C. for 5 minutes. After the heating, visual observation was performed to evaluate appearance such as deformation, discoloration, or peeling. In the case where there was no change in the visual observation, good heat resistance was determined, and in the case where deformation, discoloration, peeling, or the like occurred, poor heat resistance was determined.

TABLE 5

| | | | Surface roughness | | Thermal insulation | | |
|---|---|---|---|---|---|---|---|
| | | | (Ra) of main | | property (surface | | |
| | Constitution | | body part | | temperature) | Flame | Heat |
| Item | Aerogel layer | Main body part | μm | Adhesion | ° C. | retardance | resistance |
| Example III-1 | Aerogel layer | Main body part III-1 | 0.03 | A | 36 | Anti-flame | Good |
| | III-1 | (aluminum plate) | | | | grade 1 | |
| Example III-2 | Aerogel layer | Main body part III-2 | 0.16 | A | 34 | Anti-flame | Good |
| | III-2 | (polyimide plate) | | | | grade 1 | |
| Example III-3 | Aerogel layer | Main body part III-3 | 0.29 | A | 36 | Anti-flame | Good |
| | III-3 | (aluminum alloy plate) | | | | grade 1 | |
| Example III-4 | Aerogel layer | Main body part III-4 | 1.1 | A | 35 | Anti-flame | Good |
| | III-4 | (alumina plate) | | | | grade 1 | |
| Example III-5 | Aerogel layer | Main body part III-5 | 3.5 | A | 35 | Anti-flame | Good |
| | III-5 | (alumina plate) | | | | grade 1 | |
| Example III-6 | Aerogel layer | Main body part III-6 | 12 | A | 42 | Anti-flame | Good |
| | III-1 | (alumina plate) | | | | grade 1 | |
| Example III-7 | Aerogel layer | Main body part III-7 | 0.0003 | C | — | — | — |
| | III-1 | (polyester film) | | | | | |
| Example III-8 | Aerogel layer | Main body part III-8 | 0.007 | C | — | — | — |
| | III-1 | (polyaramide film) | | | | | |

From Table 5, it is evident that Examples III-1 to III-6 in which the surface roughness (Ra) of the main body part is 0.01 μm or larger are excellent in adhesion.

### Examples IV-1 to IV-12 and Comparative Examples IV-1 to IV-3

### (Component Constituting Engine)

An aluminum alloy plate (A6061P, alumite-treated, size: 300 mm×300 mm×0.5 mm, manufactured by Takeuchi Metal & Foil Co., Ltd.) was provided as a component constituting an engine.

### Examples IV-1 to IV-12

### (Formation of Covering Layer (Intermediate Layer))

Intermediate layers IV-1 to IV-5 were formed on the provided aluminum alloy plate (component) as described below according to the combinations shown in Table 6. Aside from this, test specimens corresponding to the intermediate layers IV-1 to IV-5 were prepared, and the percentages of water absorption of the intermediate layers IV-1 to IV-5 were measured. Specifically, the rate of change in mass in leaving the test specimen of each intermediate layer molded into a size of 20 mm×20 mm×0.5 mm for 6 hours in a thermo-hygrostat of 60° C. and 90% RH was regarded as the percentage of water absorption. The measurement results are shown in Table 6.

[Intermediate Layer IV-1]

The aluminum alloy plate (component) was coated by using an air brush (manufactured by ANEST IWATA Corporation, product name: HP-CP) with Silicon HR Primer (product name, manufactured by Chugoku Marine Paints, Ltd.) as a silicone-based primer liquid, which was then cured by heating at 40° C. for 1 hour and further at 200° C. for 2 hours to form a layer having a thickness of 30 μm (intermediate layer IV-1) on the component.

[Intermediate Layer IV-2]

The aluminum alloy plate (component) was coated by using a bar coater with a mixture of Aron Ceramic E (product name, manufactured by Toa Gosei Co., Ltd.) and fused silica (manufactured by Admatechs Co., Ltd., SO-25R) as an inorganic primer liquid, which was then cured by heating at 90° C. for 1 hour and further at 150° C. for 2 hours to form a layer having a thickness of 100 μm (intermediate layer IV-2) on the component. The content of the fused silica (filler) contained in the obtained intermediate layer IV-2 was 0.5% by volume with respect to the total volume of the intermediate layer.

[Intermediate Layer IV-3]

The aluminum alloy plate (component) was coated by using a bar coater with a sodium silicate solution (approximately 38% by mass) (manufactured by Wako Pure Chemical Industries, Ltd., reagent) as an inorganic primer liquid, which was then cured by heating at 300° C. for 2 hours to form a layer having a thickness of 50 μm (intermediate layer IV-3) on the component.

[Intermediate Layer IV-4]

The aluminum alloy plate (component) was coated by using a bar coater with a mixture of TB3732 (product name, manufactured by ThreeBond Holdings Co., Ltd.) and magnesium hydroxide (manufactured by Wako Pure Chemical Industries, Ltd., reagent) as an inorganic primer liquid, which was then cured by heating at 50° C. for 30 minutes and further at 100° C. for 1 hour to form a layer having a thickness of 10 μm (intermediate layer IV-4) on the component. The content of the magnesium hydroxide (filler) contained in the obtained intermediate layer IV-4 was 20% by volume with respect to the total volume of the intermediate layer.

[Intermediate Layer IV-5]

API-114A (product name, manufactured by Chukoh Chemical Industries, Ltd.) as a polyimide-based pressure-sensitive adhesive tape was attached to the aluminum alloy plate (component) to form a layer having a thickness of 60 pin (intermediate layer IV-5) on the component.

(Sol Coating Liquid)

### [Sol Coating Liquid IV-1]

100.0 parts by mass of PL-2L (product name, manufactured by Fuso Chemical Co., Ltd., average primary particle diameter: 20 nm, solid content: 20% by mass) as a silica particle-containing raw material, 120.0 parts by mass of water, 80.0 parts by mass of methanol and 0.10 parts by mass of acetic acid as an acid catalyst were mixed to obtain a mixture. 60.0 parts by mass of methyltrimethoxysilane (manufactured by Shin-Etsu Chemical Co., Ltd., product name: LS-530; also referred to as “MTMS”) and 40.0 parts by mass of dimethyldimethoxysilane (manufactured by Shin-Etsu Chemical Co., Ltd., product name: LS-520; also referred to as “DMDMS”) were added as silicon compounds to this mixture, and reacted at 25° C. for 2 hours. 40.0 parts by mass of 5% concentration of ammonia water were added thereto as a base catalyst to obtain sol coating liquid IV-1.

### [Sol Coating Liquid IV-2]

100.0 parts by mass of ST-OZL-35 (product name, manufactured by Nissan Chemical Industries, Ltd., average primary particle diameter: 100 nm, solid content: 35% by mass) as a silica particle-containing raw material, 100.0 parts by mass of water, 0.10 parts by mass of acetic acid as an acid catalyst, 20.0 parts by mass of CTAB as a cationic surfactant and 120.0 parts by mass of urea as a thermally hydrolyzable compound were mixed to obtain a mixture. 60.0 parts by mass of MTMS as a silicon compound and 20.0 parts by mass of X-22-160AS (product name, manufactured by Shin-Etsu Chemical Co., Ltd.) as a polysiloxane compound having a structure represented by the above formula (A) were added to this mixture, and reacted at 25° C. for 2 hours. Then, sol-gel reaction was performed at 60° C. for 5 hours to obtain sol coating liquid IV-2.

[Sol Coating Liquid IV-3]

100.0 parts by mass of PL-2L as a silica particle-containing raw material, 100.0 parts by mass of water, 0.10 parts by mass of acetic acid as an acid catalyst, 20.0 parts by mass of CTAB as a cationic surfactant and 120.0 parts by mass of urea as a thermally hydrolyzable compound were mixed to obtain a mixture. 80.0 parts by mass of MTMS as a silicon compound and 20.0 parts by mass of a both terminally difunctional alkoxy-modified polysiloxane compound having a structure represented by the above formula (B) (hereinafter, referred to as “polysiloxane compound IV-A”) as a polysiloxane compound were added to this mixture, and reacted at 25° C. for 2 hours. Then, sol-gel reaction was performed at 60° C. for 2 hours to obtain sol coating liquid IV-3.

The “polysiloxane compound IV-A” was synthesized as follows: first, in a 1 L three-neck flask equipped with a stirrer, a thermometer and a Dimroth condenser, 100.0 parts by mass of dimethylpolysiloxane having silanol groups at both ends (manufactured by Momentive Performance Materials Inc., product name: XC96-723), 181.3 parts by mass of methyltrimethoxysilane and 0.50 parts by mass of t-butylamine were mixed and reacted at 30° C. for 5 hours. Then, volatile matter was removed by heating this reaction solution under reduced pressure of 1.3 kPa at 140° C. for 2 hours, to obtain the both terminally difunctional alkoxy-modified polysiloxane compound (polysiloxane compound IV-A).

[Sol Coating Liquid IV-4]

100.0 parts by mass of PL-2L as a silica particle-containing raw material, 200.0 parts by mass of water, 0.10 parts by mass of acetic acid as an acid catalyst, 20.0 parts by mass of CTAB as a cationic surfactant and 120.0 parts by mass of urea as a thermally hydrolyzable compound were mixed to obtain a mixture. 60.0 parts by mass of MTMS as a silicon compound and 40.0 parts by mass of a both terminally trifunctional alkoxy-modified polysiloxane compound having a structure represented by the above formula (B) (hereinafter, referred to as “polysiloxane compound IV-B”) as a polysiloxane compound were added to this mixture, and reacted at 25° C. for 2 hours. Then, sol-gel reaction was performed at 60° C. for 2 hours to obtain sol coating liquid IV-4.

The “polysiloxane compound IV-B” was synthesized as follows: first, in a 1 L three-neck flask equipped with a stirrer, a thermometer and a Dimroth condenser, 100.0 parts by mass of XC96-723, 202.6 parts by mass of tetramethoxysilane and 0.50 parts by mass of t-butylamine were mixed and reacted at 30° C. for 5 hours. Then, volatile matter was removed by heating this reaction solution under reduced pressure of 1.3 kPa at 140° C. for 2 hours, to obtain the both terminally trifunctional alkoxy-modified polysiloxane compound (polysiloxane compound IV-B).

[Sol Coating Liquid IV-5]

100.0 parts by mass of PL-2L as a silica particle-containing raw material, 100.0 parts by mass of water, 0.10 parts by mass of acetic acid as an acid catalyst, 20.0 parts by mass of CTAB as a cationic surfactant and 120.0 parts by mass of urea as a thermally hydrolyzable compound were mixed to obtain a mixture. 60.0 parts by mass of MTMS and 40.0 parts by mass of DMDMS were added as silicon compounds to this mixture, and reacted at 25° C. for 2 hours. Then, sol-gel reaction was performed at 60° C. for 1.0 hour to obtain sol coating liquid IV-5.

[Sol Coating Liquid IV-6]

100.0 parts by mass of PL-2L as a silica particle-containing raw material, 100.0 parts by mass of water, 0.10 parts by mass of acetic acid as an acid catalyst, 20.0 parts by mass of CTAB as a cationic surfactant and 120.0 parts by mass of urea as a thermally hydrolyzable compound were mixed to obtain a mixture. 60.0 parts by mass of MTMS and 20.0 parts by mass of DMDMS as silicon compounds, and 20.0 parts by mass of X-22-160AS as a polysiloxane compound were added to this mixture, and reacted at 25° C. for 2 hours. Then, sol-gel reaction was performed at 60° C. for 1.0 hour to obtain sol coating liquid IV-6.

[Sol Coating Liquid IV-7]

100.0 parts by mass of PL-2L as a silica particle-containing raw material, 100.0 parts by mass of water, 0.10 parts by mass of acetic acid as an acid catalyst, 20.0 parts by mass of CTAB as a cationic surfactant and 120.0 parts by mass of urea as a thermally hydrolyzable compound were mixed to obtain a mixture. 60.0 parts by mass of MTMS and 20.0 parts by mass of DMDMS as silicon compounds, and 20.0 parts by mass of the polysiloxane compound IV-A as a polysiloxane compound were added to this mixture, and reacted at 25° C. for 2 hours. Then, sol-gel reaction was performed at 60° C. for 1.0 hour to obtain sol coating liquid IV-7.

(Preparation of Thermally Insulated Body (Aerogel Composite Structure))

Aerogel layers IV-1 to IV-7 as thermal insulating layers were formed on the component or on the intermediate layers as described below according to the combinations shown in Table 6 to prepare aerogel composite structures having an aerogel layer integrally joined with the component directly or via an intermediate layer.

[Aerogel Layer IV-1]

The sol coating liquid IV-1 was applied onto the component or onto the intermediate layer by using an air brush (manufactured by ANEST IWATA Corporation, product name: HP-CP) such that the thickness after gelling became 100 μm, and gelled at 60° C. for 30 minutes to obtain a structure. Then, the obtained structure was transferred to a closed vessel and aged at 60° C. for 12 hours.

Then, the aged structure was dipped in 2000 mL of water and washed over 30 minutes. Next, the resultant was dipped in 2000 mL of methanol and washed at 60° C. over 30 minutes. Washing with methanol was further performed twice while the methanol was replaced with a fresh one. Next, the resultant was dipped in 2000 mL of methyl ethyl ketone, and solvent replacement was performed at 60° C. over 30 minutes. Washing with methyl ethyl ketone was further performed twice while the methyl ethyl ketone was replaced with a fresh one. The washed and solvent-replaced structure was dried under normal pressure at 120° C. for 6 hours to obtain an aerogel composite structure having aerogel layer IV-1 (aerogel layer integrally joined with the component directly or via the intermediate layer).

[Aerogel Layer IV-2]

The sol coating liquid IV-2 was applied onto the component or onto the intermediate layer by using a bar coater such that the thickness after gelling became 200 μm, and gelled at 60° C. for 30 minutes to obtain a structure. Then, the obtained structure was transferred to a closed vessel and aged at 60° C. for 12 hours.

Then, the washing and solvent replacement step and the drying step were performed in the same way as the method described in “Aerogel layer IV-1” to obtain an aerogel composite structure having aerogel layer IV-2 (aerogel layer integrally joined with the component directly or via the intermediate layer) containing aerogel having structures represented by the above formulas (1), (1a) and (4).

[Aerogel Layer IV-3]

The sol coating liquid IV-3 was placed in a tray, and the component or the component with the intermediate layer formed was dipped in the sol coating liquid IV-3 and then taken out, followed by gelling at 60° C. for 30 minutes to obtain a structure having a gel layer thickness of 100 μm. Then, the obtained structure was transferred to a closed vessel and aged at 60° C. for 12 hours.

Then, the washing and solvent replacement step and the drying step were performed in the same way as the method described in “Aerogel layer IV-1” to obtain an aerogel composite structure having aerogel layer IV-3 (aerogel layer integrally joined with the component directly or via the intermediate layer) containing aerogel having structures represented by the above formulas (2), (3), (4) and (5).

[Aerogel Layer IV-4]

An aerogel composite structure having aerogel layer IV-4 (aerogel layer integrally joined with the component directly or via the intermediate layer) containing aerogel having structures represented by the above formulas (2) and (4) was obtained in the same way as the method described in “Aerogel layer IV-1” except that the sol coating liquid IV-4 was used instead of the sol coating liquid IV-1, and the thickness after gelling was set to 50 μm.

[Aerogel Layer IV-5]

An aerogel composite structure having aerogel layer IV-5 (aerogel layer integrally joined with the component directly or via the intermediate layer) containing aerogel having structures represented by the above formulas (4) and (5) was obtained in the same way as the method described in “Aerogel layer IV-1” except that the sol coating liquid IV-5 was used instead of the sol coating liquid IV-1.

[Aerogel Layer IV-6]

An aerogel composite structure having aerogel layer IV-6 (aerogel layer integrally joined with the component directly or via the intermediate layer) containing aerogel having structures represented by the above formulas (1), (1a), (4) and (5) was obtained in the same way as the method described in “Aerogel layer IV-I” except that the sol coating liquid IV-6 was used instead of the sol coating liquid IV-1.

[Aerogel Layer IV-7]

An aerogel composite structure having aerogel layer IV-7 (aerogel layer integrally joined with the component directly or via the intermediate layer) containing aerogel having structures represented by the above formulas (2), (3), (4) and (5) was obtained in the same way as the method described in “Aerogel layer IV-1” except that the sol coating liquid IV-7 was used instead of the sol coating liquid IV-1.

TABLE 6

| | | | Percentage of water | | |
|---|---|---|---|---|---|
| | | Filler in | absorption of | | Thickness of |
| | | intermediate | intermediate layer | Aerogel | aerogel layer |
| Item | Intermediate layer | layer | (%) | layer | (μm) |
| Example IV-1 | None | None | None | Aerogel layer | 100 |
| | | | | IV-1 | |
| Example IV-2 | Intermediate layer | Fused silica | 1.0 | Aerogel layer | 200 |
| | IV-2 (inorganic) | | | IV-2 | |
| Example IV-3 | Intermediate layer | None | 0.5 | Aerogel layer | 100 |
| | IV-3 (inorganic) | | | IV-1 | |
| Example IV-4 | None | None | None | Aerogel layer | 100 |
| | | | | IV-3 | |
| Example IV-5 | Intermediate layer | None | 0.8 | Aerogel layer | 50 |
| | IV-1 (silicone-based) | | | IV-4 | |
| Example IV-6 | None | None | None | Aerogel layer | 100 |
| | | | | IV-5 | |
| Example IV-7 | Intermediate layer | None | 2.5 | Aerogel layer | 100 |
| | IV-5 (polyimide-based) | | | IV-6 | |
| Example IV-8 | Intermediate layer | Magnesium | 1.8 | Aerogel layer | 100 |
| | IV-4 (inorganic) | hydroxide | | IV-1 | |
| Example IV-9 | None | None | None | Aerogel layer | 50 |
| | | | | IV-4 | |
| Example IV-10 | Intermediate layer | None | 0.8 | Aerogel layer | 100 |
| | IV-1 (silicone-oased) | | | IV-7 | |

### Comparative Example IV-1

The aluminum alloy plate which was a component was directly used.

### Comparative Example IV-2

Urethane foam (manufactured by Henkel Japan Ltd., product name: Sista M5230) was applied to the aluminum alloy plate as a component such that the thickness became 100 μm, to obtain a urethane foam structure.

### Comparative Example IV-3

Zirconia was thermally sprayed to the aluminum alloy plate as a component. By this, a ceramic coating film (thickness: 100 μm) was formed on the aluminum alloy plate to obtain a ceramic composite structure.

<Various Evaluations>

### (Thermal Insulation Property Evaluation)

The aerogel composite structure obtained in each Example or the structure obtained in each Comparative Example (aluminum alloy plate, urethane foam structure and ceramic composite structure) was placed on a hot plate with a surface temperature of 300° C. such that the aluminum layer became an upper surface, and heated, and 1 minute later, the surface temperature of the structure was measured by thermography (manufactured by Apiste Corporation, Infrared Thermoviewer FSV-1200-L16). The measurement results are shown in Table 7. The sample temperature before the heating and room temperature are 23° C.

(Flame Retardance Evaluation)

Flame retardance evaluation was conducted by contacting flame with the aerogel composite structure obtained in each Example or the structure obtained in each Comparative Example (aluminum alloy plate, urethane foam structure and ceramic composite structure) in accordance with JIS A 1322 (Testing Method for Incombustibility of Thin Materials for Buildings). The evaluation results are shown in Table 7.

(Heat Resistance Evaluation)

The aerogel composite structure obtained in each Example or the structure obtained in each Comparative Example (aluminum alloy plate, urethane foam structure and ceramic composite structure) was placed on a hot plate with a surface temperature of 300° C. such that the aluminum layer became an upper surface, and heated at 300° C. for 5 minutes. After the heating, visual observation was performed to evaluate appearance such as deformation, discoloration, or peeling. In the case where there was no change in the visual observation, good heat resistance was determined, and in the case where deformation, discoloration, peeling, or the like occurred, poor heat resistance was determined.

TABLE 7

| | Constitution | | Thermal insulation | | |
|---|---|---|---|---|---|
| | | Thermal | property (surface | Flame | Heat |
| Item | Intermediate layer | insulating layer | temperature) | retardance | resistance |
| Example IV-1 | None | Aerogel layer | 70° C. | Anti-flame | Good |
| | | IV-1 | | grade 1 | |
| Example IV-2 | Intermediate layer | Aerogel layer | 67° C. | Anti-flame | Good |
| | IV-2 (inorganic) | IV-2 | | grade 1 | |
| Example IV-3 | Intermediate layer | Aerogel layer | 70° C | Anti-flame | Good |
| | IV-3 (inorganic) | IV-1 | | grade 1 | |
| Example IV-4 | None | Aerogel layer | 70° C. | Anti-flame | Good |
| | | IV-3 | | grade 1 | |
| Example IV-5 | Intermediate layer | Aerogel layer | 62° C. | Anti-flame | Good |
| | IV-1 (silicone-based) | IV-4 | | grade 1 | |
| Example IV-6 | None | Aerogel layer | 63° C. | Anti-flame | Good |
| | | IV-5 | | grade 1 | |
| Example IV-7 | Intermediate layer | Aerogel layer | 69° C | Anti-flame | Good |
| | IV-5 (polyimide-based) | IV-6 | | grade 1 | |
| Example IV-8 | Intermediate layer | Aerogel layer | 70° C. | Anti-flame | Good |
| | IV-4 (inorganic) | IV-1 | | grade 1 | |
| Example IV-9 | None | Aerogel layer | 66° C. | Anti-flame | Good |
| | | IV-4 | | grade 1 | |
| Example IV-10 | Intermediate layer | Aerogel layer | 68° C. | Anti-flame | Good |
| | IV-1 (silicone-based) | IV-7 | | grade 1 | |
| Comparative | None | None | 270° C. | Anti-flame | Good |
| Example IV-1 | | | | grade 1 | |
| Comparative | None | Urethane foam | Not evaluable | Combustion | Poor |
| Example IV-2 | | layer | (melting) | | (melting) |
| Comparative | None | Ceramic layer | 220° C. | Anti-flame | Poor |
| Example IV-3 | | | | grade 1 | (crack) |

From Table 7, in Examples, all of the thermal insulation properties, the flame retardance and the heat resistance are good. Therefore, reduction in thickness as compared with conventional materials is possible even in the case of use in a high-temperature environment, and flame retardance can be conferred. On the other hand, in Comparative Examples, thermal insulation properties are poor (thermal conductivity is high), and effects equivalent to Examples cannot be obtained. In Comparative Example IV-2, the properties of flame retardance are also poor. In Comparative Example IV-3, the properties of flame retardance and heat resistance are also poor.

### REFERENCE SIGNS LIST

3 . . . Main body part, 3a . . . Surface of the main body part, 5 . . . Thermal insulating layer, 5a . . . Sol, 10 . . . Thermal insulation object, 10a . . . Surface of the thermal insulation object, 4 . . . Covering layer, 4a . . . Surface of the covering layer on the side opposite to the main body part, 100 and 200 . . . Thermally insulated body, L . . . Bounding rectangle, P . . . Silica particle.

1. A method for manufacturing a thermally insulated body comprising a thermal insulating layer integrally formed with a thermal insulation object, the method comprising
a step of applying sol to the thermal insulation object and forming a thermal insulating layer including aerogel from the sol.

2. The method for manufacturing a thermally insulated body according to claim 1, wherein the thermal insulation object has a main body part and a covering layer covering at least a portion of a surface of the main body part, and the sol is applied onto at least the covering layer such that the covering layer becomes an intermediate layer.

3. The method for manufacturing a thermally insulated body according to claim 2, wherein a thickness of the covering layer is 0.01 to 1000 μm.

4. The method for manufacturing a thermally insulated body according to claim 2, wherein the covering layer contains a filler.

5. The method for manufacturing a thermally insulated body according to claim 4, wherein the filler is an inorganic filler.

6. The method for manufacturing a thermally insulated body according to claim 1, wherein the aerogel is a dried product of wet gel being a condensate of sol containing at least one selected from the group consisting of a silicon compound having a hydrolyzable functional group or a condensable functional group, and a hydrolysis product of the silicon compound having a hydrolyzable functional group.

7. The method for manufacturing a thermally insulated body according to claim 6, wherein the sol further contains silica particles.

8. The method for manufacturing a thermally insulated body according to claim 7, wherein an average primary particle diameter of the silica particles is 1 to 500 nm.

9. The method for manufacturing a thermally insulated body according to claim 1, wherein the thermal insulation object is a component constituting an engine.

10. The method for manufacturing a thermally insulated body according to claim 1, wherein the thermal insulation object includes at least one selected from the group consisting of metals, ceramics, glass and resins.

11. A thermally insulated body comprising a thermal insulating layer integrally formed with a thermal insulation object, wherein
the thermal insulating layer includes aerogel.

12. The thermally insulated body according to claim 11, wherein the thermal insulation object has a main body part and a covering layer covering at least a portion of a surface of the main body part, and the thermal insulating layer is formed on at least the covering layer such that the covering layer becomes an intermediate layer.

13. The thermally insulated body according to claim 12, wherein a thickness of the covering layer is 0.01 to 1000 nm.

14. The thermally insulated body according to claim 12, wherein the covering layer contains a filler.

15. The thermally insulated body according to claim 14, wherein the filler is an inorganic filler.

16. The thermally insulated body according to claim 11, wherein the aerogel is a dried product of wet gel being a condensate of sol containing at least one selected from the group consisting of a silicon compound having a hydrolyzable functional group or a condensable functional group, and a hydrolysis product of the silicon compound having a hydrolyzable functional group.

17. The thermally insulated body according to claim 16, wherein the sol further contains silica particles.

18. The thermally insulated body according to claim 17, wherein an average primary particle diameter of the silica particles is 1 to 500 nm.

19. The thermally insulated body according to claim 11, wherein the thermal insulation object is a component constituting an engine.

20. The thermally insulated body according to claim 11, wherein the thermal insulation object includes at least one selected from the group consisting of metals, ceramics, glass and resins.
